(19) United States
(12) Patent Application Publication
(10) Pub. No.: US 2026/0299290 A1
(43) Pub. Date: Oct. 1, 2026

(54) OPTICAL DEVICE FOR AUGMENTED REALITY PROVIDING EXPANDED EYE BOX

(71) Applicant: LETINAR CO., LTD, Anyang-si, Gyeonggi-do (KR)

(72) Inventor: Jeong Hun HA, Seoul (KR)

(73) Assignee: LETINAR CO., LTD, Anyang-si, Gyeonggi-do (KR)

(21) Appl. No.: 18/880,529

(22) PCT Filed: Jun. 29, 2023
(86) PCT No.: PCT/KR2023/009150

§ 371 Date: Dec. 31, 2024

(30) Foreign Application Priority Data
Jul. 4, 2022 (KR) 10-2022-0082076
Jul. 22, 2022 (KR) 10-2022-0090979

(51) Int. Cl. G02B 27/01; G02B 5/08; G02B 5/18; G02B 27/00

(52) U.S. Cl. CPC G02B 27/0101; G02B 5/0808; G02B 5/1819; G02B 27/0081

(57) ABSTRACT

The present invention provides an optical device for augmented reality, the optical device including: a first optical means configured such that the virtual image light output from an image output unit propagates through the inside thereof; an optical conversion means embedded and disposed inside the first optical means, and configured to transfer the virtual image light to first optical elements; the plurality of first optical elements embedded and disposed inside the first optical means, and configured to output the virtual image light to a second optical means; the second optical means configured to transfer real object image light to the pupil of a user's eye, and also configured to allow the virtual image light to propagate through the inside thereof; and a plurality of second optical elements embedded and disposed inside the second optical means, and configured to provide a virtual image to the user.

### TECHNICAL FIELD

The present invention relates to an optical device for augmented reality, and more particularly, to an optical device for augmented reality that is suitable for compactness and light weight while providing an expanded eye box.

### BACKGROUND ART

Augmented reality (AR) refers to technology that superimposes a virtual image, provided by a computer or the like, on a real image in the real world and then provides a resulting image, thereby providing augmented virtual image information to a user, as is well known.

An apparatus for realizing such augmented reality requires an optical combiner that enables the simultaneous observation of virtual images and real images of the real world. As such optical combiners, there are known half mirror-type combiners and holographic/diffractive optical element (HOE/DOE)-type combiners.

Half mirror-type combiners have problems in that the transmittance of virtual images is low and it is difficult to provide a comfortable fit because the volume and weight thereof are increased to provide a wide FOV. In order to reduce the volume and weight, there have also been proposed technologies such as Light-guide Optical Element (LOE), which requires a plurality of small half-mirrors to be disposed inside a waveguide. This technology also has limitations in that the manufacturing process is complicated because the image light of a virtual image needs to pass through the half-mirrors a number of times inside the waveguide and in that luminous uniformity may easily be lowered due to manufacturing errors.

Furthermore, HOE/DOE-type combiners generally employ nanostructure gratings or diffraction gratings. Since they are manufactured in a significantly precise process, the technology has limitations in that the manufacturing cost is high and the yield for mass production is low. Furthermore, due to the difference in diffraction efficiency according to the wavelength band and the incident angle, this technology has limitations in terms of color uniformity and the low sharpness of an image. Holographic/diffractive optical elements are often used in conjunction with waveguides as in the LOEs described above. Accordingly, this technology still has the same problems.

Furthermore, the conventional optical combiners have limitations in that a virtual image is out of focus when a user changes a focal length when gazing at the real world. In order to overcome this problem, there has been proposed a technology using a prism capable of adjusting the focal length of a virtual image or a variable focus lens capable of electrically controlling the focal length. However, this technology also has a problem in that user needs to perform a separate operation to adjust the focal length and also separate hardware and software are required for controlling the focal length.

In order to overcome the problems of the prior art, the present applicant has developed a technology that projects a virtual image onto the retina through the pupil by using a reflective unit in the form of a pin mirror having a smaller size than the human pupil (see conventional art document 1).

FIG. 1 is a diagram showing an optical device 100 for augmented reality as described in conventional art document 1.

The optical device 100 for augmented reality of FIG. 1 includes an optical means 10 and a reflective unit 20.

An image output unit 30 may include a micro-display device that displays a virtual image on a screen and outputs virtual image light corresponding to the displayed virtual image, and an optical conversion unit that transfers the image light, output from the micro-display device, to the reflective unit 20, as a means that outputs virtual image light. In this case, the optical conversion unit is a means that allows virtual image light to be output according to an intended optical path and focal length, and may be an optical element such as a concave mirror that outputs incident virtual image light by reflecting it in order to enlarge a virtual image, or a collimator that converts incident light into parallel light and outputs the parallel light.

The optical means 10 is a means that functions to transmit real object image light, which is image light output from an object in the real world, therethrough to the pupil 40 and output the virtual image light, which is reflected by the reflective unit 20, to the pupil 40.

The optical means 10 may be made of, e. g. a transparent resin material like a glasses lens, and may be fixed by a frame (not shown) such as a glasses frame.

The reflective unit 20 is a means that transfers the virtual image light, output from the image output unit 30, toward a pupil 40 of a user by reflecting the virtual image light.

The reflective unit 20 is embedded and disposed inside the optical means 10.

The reflective unit 20 of FIG. 1 is formed to have a smaller size than a human pupil. Since it is known that the size of the average pupil of people is about 4 to 8 mm, the reflective unit 20 is preferably formed to have a size of 8 mm or less, more preferably 4 mm or less.

By forming the reflective unit 20 to be smaller than the average pupil as described above, the depth of field for light entering the pupil through the reflective unit 20 may be made almost infinite, i.e., considerably deep.

In this case, the depth of field refers to a range within which an image for augmented reality is recognized as being in focus. As the depth of field increases, the range of focal lengths for virtual images widens correspondingly. Accordingly, even when a user changes the focal length for the real world while gazing at the real world, the user always recognizes an image for augmented reality as being in focus regardless of such a change. This may be viewed as a type of pinhole effect.

Accordingly, even when the user changes the focal length while gazing at a real object present in the real world, the user may always view a clear virtual image for an image for augmented reality.

FIGS. 2 to 4 are diagrams showing an optical device 200 for augmented reality as disclosed in conventional art document 2, wherein FIG. 2 is a side view, FIG. 3 is a perspective view, and FIG. 4 is a front view.

The optical device 200 for augmented reality of FIGS. 2 to 4 has the same basic principle as the optical device 100 for augmented reality shown in FIG. 1. However, the optical device 200 for augmented reality is different from the optical device 100 for augmented reality in that a reflective unit 20 includes a plurality of reflective modules and is disposed inside the optical means 10 in the form of an array in order to widen the eye box and FOV thereof and the virtual image light output from an image output unit 30 is reflected by total internal reflection on an inner surface of the optical means 10 and then transferred to the reflective unit 20.

In FIGS. 2 to 4, reference numerals 21 to 26 denote only reflective modules viewed from a side as shown in FIG. 2, and the reflective unit 20 collectively refers to the plurality of reflective modules 21 to 26.

As described above, each of the plurality of reflective modules 21 to 26 is preferably formed to have a size of 8 mm or less, more preferably 4 mm or less.

In FIGS. 2 to 4, the virtual image light output from the image output unit 30 is reflected by total internal reflection on the inner surface of the optical means 10 and then transferred to the reflective modules 21 to 26, and the reflective modules 21 to 26 transfers the incident virtual image light to the pupil 40 by reflecting the incident virtual image light.

Accordingly, the reflective modules 21 to 26 each need to be disposed to have an appropriate inclination angle inside the optical means 10 as shown in the drawing by taking into consideration the locations of the image output unit 30 and the pupil 40.

This optical device 200 for augmented reality has the advantage of being able to expand the eye box compared to the optical device 100 for augmented reality of FIG. 1. However, when this optical device 200 for augmented reality is placed in front of the pupil 40, the eye box in the horizontal direction (the x-axis direction) is determined by the length of the optical conversion unit included in the image output unit 30, and the eye box in the vertical direction (the y-axis direction) is determined by the arrangement structure of the reflective unit 21 to 26.

Therefore, in order to expand the eye box in the horizontal direction, it is necessary to use an optical conversion unit that is longer in the horizontal direction. However, as the length of the optical conversion unit increases, the form factor such as size, weight, and volume is increased and the design of optical paths becomes more complicated.

Furthermore, in the optical device 200 for augmented reality, the image output unit 30 includes the optical conversion unit, so that there is also a problem in that it is difficult to make the device compact and lightweight.
[Conventional Art Document 1] Korean Patent Application Publication No. 10-2018-0028339 (published on Mar. 16, 2018)
[Conventional Art Document 2] Korean Patent No. 10-2192942 (published on Dec. 18, 2020)

### DISCLOSURE

### Technical Problem

An object of the present invention is to provide a compact optical device for augmented reality that may be made small and lightweight while providing an expanded eye box.

Another object of the present invention is to provide an optical device for augmented reality that may keep the form factor small by disposing a means for performing the function of an optical conversion unit inside an optical means while expanding a two-dimensional eye box in the x axis and the y axis.

Another object of the present invention is to provide an optical device for augmented reality that has an expanded eye box by using a diffractive optical element.

### Technical Solution

The present invention provides a compact optical device for augmented reality having an expanded eye box, that is, an optical device for augmented reality providing an expanded eye box, the optical device including: a first optical means configured such that the virtual image light output from an image output unit propagates through the inside thereof; an optical conversion means embedded and disposed inside the first optical means, and configured to transfer the virtual image light, propagating through the inside of the first optical means, to first optical elements; the plurality of first optical elements embedded and disposed inside the first optical means, and configured to output the virtual image light, transferred from the optical conversion unit, to a second optical means; the second optical means configured to transfer the real object image light, output from a real object, to the pupil of a user's eye by transmitting the real object image light therethrough, and also configured to allow the virtual image light, output from the first optical elements, to propagate through the inside thereof; and a plurality of second optical elements embedded and disposed inside the second optical means, and configured to provide a virtual image to the user by transferring the virtual image light, propagating through the inside of the second optical means, to the pupil of the user's eye; wherein the plurality of first optical elements are arranged at intervals in a first direction inside the first optical means; and wherein the plurality of second optical elements are arranged at intervals in a second direction inside the second optical means.

In this case, the first direction may be a direction that is parallel to any one of the line segments included in a plane perpendicular to a straight line in the forward direction of the pupil.

Furthermore, the second direction may be a direction that is not parallel to the first direction.

Furthermore, the second direction may be perpendicular to the first direction.

Furthermore, the virtual plane formed by the first direction and the second direction may be a two-dimensional plane that can be observed from the user's pupil when the optical device for augmented reality is placed in front of the user's pupil.

Furthermore, the second direction may be a direction parallel to any one of the line segments that are included in a plane perpendicular to a straight line in the forward direction of the pupil and that are perpendicular to the first direction.

Furthermore, the image output unit may be disposed at one end of the first optical means in the first direction.

Furthermore, the optical conversion unit may be embedded and disposed inside the first optical means to face the image output unit.

Furthermore, the virtual image light output from the image output unit may be reflected by total internal reflection inside the first optical means and transferred to the optical conversion unit, and the virtual image light output from the optical conversion unit may be reflected by total internal reflection inside the first optical means and transferred to the first optical elements.

Furthermore, the optical conversion unit may be a reflective means that reflects incident light.

Furthermore, the reflective surface of the optical conversion unit may be embedded and disposed inside the first optical means to face the top surface of the first optical means.

Furthermore, the reflective surface of the optical conversion unit may be a curved surface that is formed to be concave in the direction of the top surface of the first optical means.

Furthermore, the plurality of first optical elements may be arranged to be inclined inside the first optical means in order to transfer the virtual image light, output from the optical conversion unit, to the second optical means by outputting the virtual image light to the second optical means.

Furthermore, the plurality of first optical elements may be arranged inside the first optical means so that they have an inclination angle with respect to the first direction when the optical device for augmented reality is placed in front of the pupil and have an inclination angle with respect to the second direction when viewed from a side.

Furthermore, the length of each of the plurality of first optical elements in the widthwise direction thereof may be formed to correspond to the length of the image output unit in the widthwise direction thereof.

Furthermore, the plurality of first optical elements may be reflective means that reflect incident light.

Furthermore, the plurality of first optical elements may be half mirrors that transmit part of incident light therethrough and reflect part of it therefrom.

Furthermore, the plurality of first optical elements may be formed of any one of refractive elements, diffractive elements, and holographic optical elements, or a combination thereof.

Furthermore, each of the plurality of first optical elements may be formed of a plurality of optical modules.

Furthermore, each of the plurality of first optical elements may be formed of a plurality of optical modules that are arranged to be spaced apart from each other and appear in an array form when the optical device for augmented reality is viewed from a side.

Furthermore, the size of the plurality of optical modules may be 4 mm or less.

Furthermore, each of the plurality of second optical elements may be arranged to be inclined inside the second optical means so that it can transfer the virtual image light, propagating through the inside of the second optical means, to the pupil.

Furthermore, the second optical means may have a first surface through which the virtual image light and the real object image light are output toward the user's pupil, and a second surface which faces the first surface and on which the real object image light is incident; the virtual image light output from the first optical elements may be reflected by total internal reflection on the second surface of the second optical means and transferred to the plurality of second optical elements; and the plurality of second optical elements may each be arranged at an inclination angle inside the second optical means so that the virtual image light reflected by total internal reflection on the second surface of the second optical means can be transferred to the pupil.

Furthermore, the plurality of second optical elements may each be formed in a bar shape extending in the first direction.

Furthermore, the plurality of second optical elements may have a height of 4 mm or less when viewed from the front.

Furthermore, each of the plurality of second optical elements may be formed of a plurality of optical modules.

Furthermore, each of the plurality of second optical elements may be formed of a plurality of optical modules that are arranged to be spaced apart from each other and appear in an array form when the optical device for augmented reality is viewed from the front.

Furthermore, the size of the plurality of optical modules may be 4 mm or less.

Furthermore, the plurality of second optical elements may be reflective means that reflect incident light.

Furthermore, the plurality of second optical elements may be half mirrors that transmit part of incident light therethrough and reflect part of it therefrom.

Furthermore, the plurality of second optical elements may be formed of any one of refractive elements, diffractive elements, and holographic optical elements, or a combination thereof.

Furthermore, the first optical means and the second optical means may be integrated with each other.

According to another aspect of the present invention, there is provided an eye box expansion-type optical device for augmented reality using a diffractive optical element, that is, an optical device for augmented reality providing an expanded eye box, the optical device including: a first optical means configured such that the virtual image light output from an image output unit propagates through the inside thereof; a first optical element disposed in the first optical means, and configured to output the virtual image light, propagating through the inside of the first optical means, to a second optical means; the second optical means configured to transfer the real object image light, output from a real object, to the pupil of a user's eye by transmitting the real object image light therethrough, and also configured to allow the virtual image light, output from the first optical element, to propagate through the inside thereof; and a plurality of second optical elements embedded and disposed inside the second optical means, and configured to provide a virtual image to the user by transferring the virtual image light, propagating through the inside of the second optical means, to the pupil of the user's eye; wherein the first optical element is a diffractive optical element or a holographic optical element; wherein the first optical element is extended in a first direction and arranged in the first optical means; and wherein the plurality of second optical elements are arranged at intervals in a second direction inside the second optical means.

In this case, the first direction may be a direction that is parallel to any one of the line segments included in a plane perpendicular to a straight line in the forward direction of the pupil.

Furthermore, the second direction may be a direction that is not parallel to the first direction.

Furthermore, the second direction may be perpendicular to the first direction.

Furthermore, the virtual plane formed by the first direction and the second direction may be a two-dimensional plane that can be observed from the user's pupil when the optical device for augmented reality is placed in front of the user's pupil.

Furthermore, the second direction may be a direction parallel to any one of the line segments that are included in a plane perpendicular to a straight line in the forward direction of the pupil and that are perpendicular to the first direction.

Furthermore, the image output unit may be disposed at one end of the first optical means in the first direction.

Furthermore, the first optical element may be disposed on the top or bottom surface of the first optical means or inside the first optical means.

Furthermore, the first optical element may be disposed on/in the first optical means to have an inclination angle with respect to the second direction when the optical device for augmented reality is placed in front of the pupil and viewed from a side.

Furthermore, each of the plurality of second optical elements may be arranged to be inclined inside the second optical means so that it can transfer the virtual image light, propagating through the inside of the second optical means, to the pupil.

Furthermore, the second optical means may have a first surface through which the virtual image light and the real object image light are output toward the user's pupil, and a second surface which faces the first surface and on which the real object image light is incident; the virtual image light output from the first optical elements may b reflected by total internal reflection on the second surface of the second optical means and transferred to the plurality of second optical elements; and the plurality of second optical elements may each be arranged at an inclination angle inside the second optical means so that the virtual image light reflected by total internal reflection on the second surface of the second optical means can be transferred to the pupil.

Furthermore, the plurality of second optical elements may each be formed in a plate shape extending in the first direction.

Furthermore, the plurality of second optical elements may have a height of 4 mm or less when viewed from the front.

Furthermore, each of the plurality of second optical elements may be formed of a plurality of optical modules.

Furthermore, each of the plurality of second optical elements may be formed of a plurality of optical modules that are arranged to be spaced apart from each other and appear in an array form when the optical device for augmented reality is viewed from the front.

Furthermore, the size of the plurality of optical modules may be 4 mm or less.

Furthermore, the plurality of second optical elements may be reflective means that reflect incident light.

Furthermore, the plurality of second optical elements may be half mirrors that transmit part of incident light therethrough and reflect part of it therefrom.

Furthermore, the plurality of second optical elements may be formed of any one of refractive elements, diffractive elements, and holographic optical elements, or a combination thereof.

Furthermore, the first optical means and the second optical means may be integrated with each other.

### Advantageous Effects

According to the present invention, there may be provided the compact optical device for augmented reality that may be made small and lightweight while providing an expanded eye box.

In particular, the present invention may provide the optical device for augmented reality that may keep the form factor small by disposing a means for performing the function of an optical conversion unit inside an optical means while expanding a two-dimensional eye box in the x axis and the y axis.

According to the present invention, there may be provided the optical device for augmented reality that has an expanded eye box by using a diffractive optical element.

### DESCRIPTION OF DRAWINGS

FIG. 1 is a diagram showing an optical device (100) for augmented reality as described in conventional art document 1;

FIGS. 2 to 4 are diagrams showing an optical device (200) for augmented reality as disclosed in conventional art document 2, wherein FIG. 2 is a side view, FIG. 3 is a perspective view, and FIG. 4 is a front view;

FIGS. 5 to 7 are diagrams illustrating an optical device (300) for augmented reality according to a first embodiment of the present invention, wherein FIG. 5 is a perspective view, FIG. 6 is a front view, and FIG. 7 is side view;

FIG. 8 is a diagram illustrating the arrangement structure of first optical elements (60);

FIG. 9 is a diagram illustrating the arrangement structure of second optical elements (20);

FIG. 10 is a diagram illustrating an eye box in the first direction (the x-axis direction) in the conventional optical device (200) of FIGS. 2 to 4, and is a front view when the optical device (200) is placed in front of the pupil (40);

FIG. 11 is a diagram illustrating an eye box in the first direction in the optical device (300) of FIGS. 5 to 7, and is a drawing when the optical device (300) is placed in front of the pupil (40) and viewed from the pupil (40) in the direction indicated by A of FIG. 7;

FIGS. 12 to 14 are diagrams illustrating an optical device (400) according to a modification of the first embodiment of the present invention, wherein FIG. 12 is a perspective view, FIG. 13 is a front view, and FIG. 14 is a side view;

FIGS. 15 to 17 are diagrams illustrating an optical device (500) according to another modification of the first embodiment of the present invention, wherein FIG. 15 is a perspective view, FIG. 16 is a front view, and FIG. 17 is a side view;

FIGS. 18 to 20 are diagrams illustrating an optical device (600) for augmented reality providing an expanded eye box according to a second embodiment e of the present invention, wherein FIG. 18 is a perspective view, FIG. 19 is a front view, and FIG. 20 is a side view;

FIG. 21 is a diagram illustrating an eye box in the first direction in the optical device (600) of FIGS. 18 to 20, and is a drawing when viewed in the direction indicated by A of FIG. 20;

FIGS. 22 to 24 are diagrams illustrating an optical device (700) according to a modification of the second embodiment of the present invention, wherein FIG. 22 is a perspective view, FIG. 23 is a front view, and FIG. 24 is a side view;

FIGS. 25 to 27 are diagrams illustrating an optical device (800) according to another modification of the second embodiment of the present invention, wherein FIG. 25 is a perspective view, FIG. 26 is a front view, and FIG. 27 is a side view; and

FIGS. 28 to 30 are diagrams illustrating an optical device (900) according to still another modification of the second embodiment of the present invention, wherein FIG. 28 is a perspective view, FIG. 29 is a front view, and FIG. 30 is a side view.

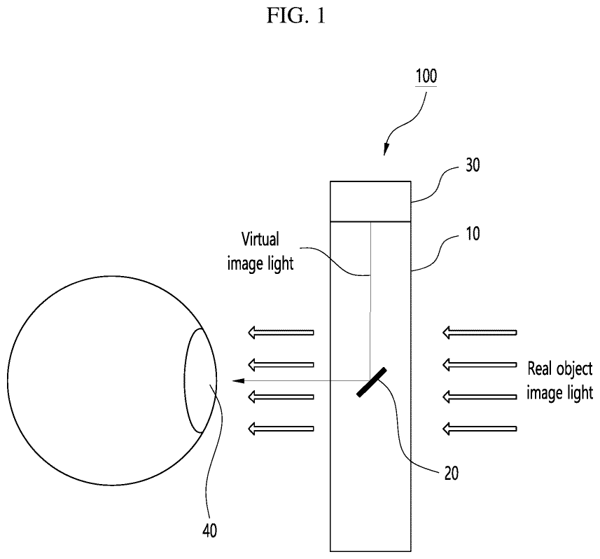

### BEST MODE

Embodiments according to the present invention will be described in detail below with reference to the accompanying drawings.

### FIRST EMBODIMENT

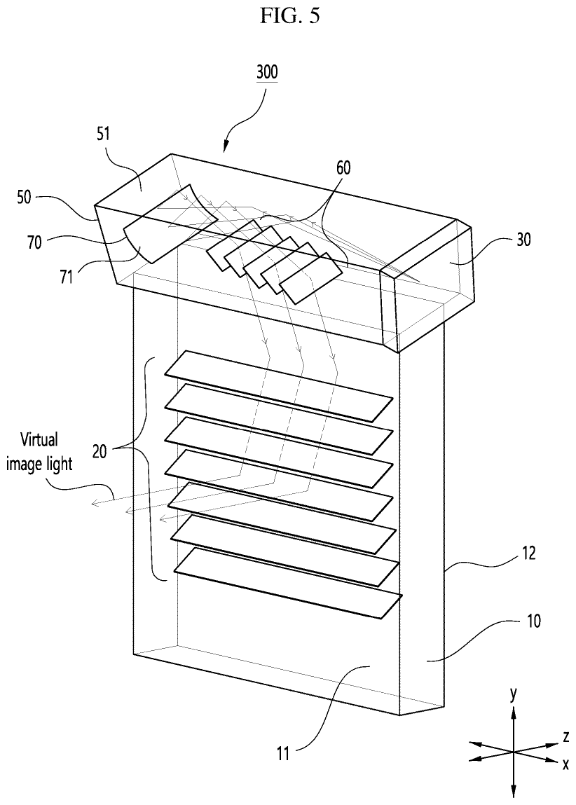

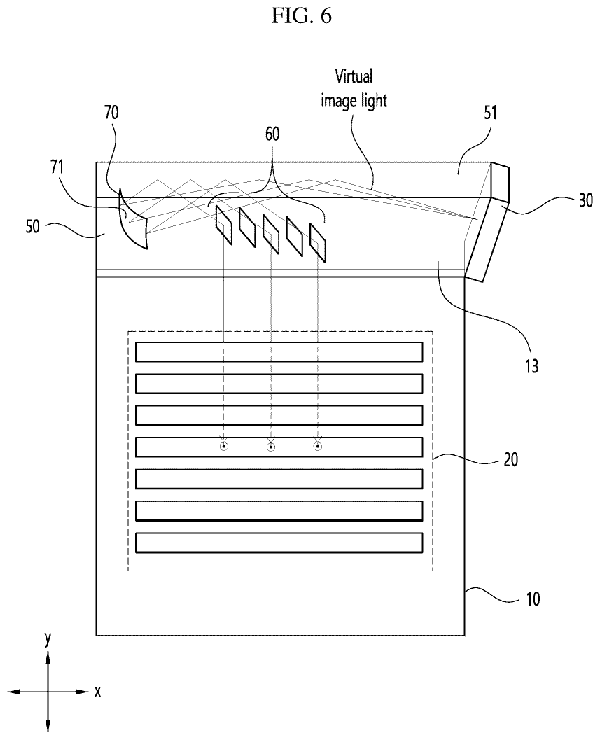

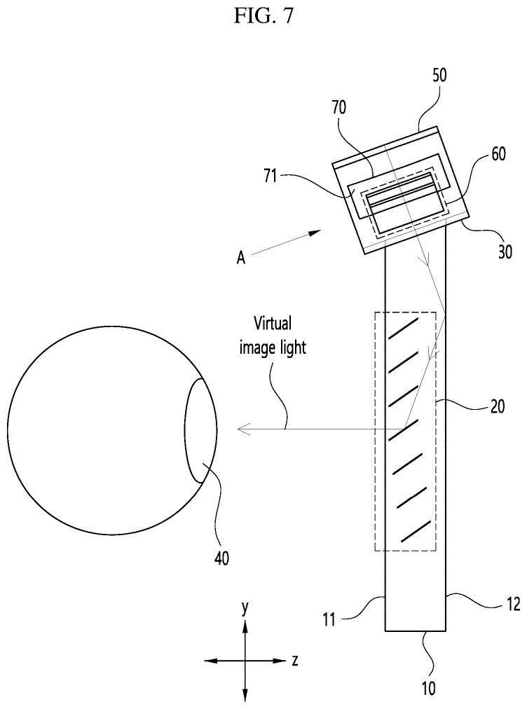

FIGS. 5 to 7 are diagrams illustrating an optical device 300 for augmented reality providing an expanded eye box according to a first embodiment of the present invention, wherein FIG. 5 is a perspective view, FIG. 6 is a front view, and FIG. 7 is a side view.

However, for ease of illustration, an image output unit 30 is shown as transparent in FIG. 7.

Referring to FIGS. 5 to 7, the optical device 300 for augmented reality providing an expanded eye box (hereinafter simply referred to as the “optical device 300”) includes a first optical means 50, an optical conversion unit 70, first optical elements 60, a second optical means 10, and second optical elements 20.

The first optical means 50 is a means through which the virtual image light output from the image output unit 30 propagates, and functions as a waveguide.

The plurality of first optical elements 60 are embedded in the first optical means 50, as will be described below.

Furthermore, the optical conversion unit 70 is embedded in the first optical means 50.

The first optical means 50 may have an approximately rectangular hexahedral shape, as shown in the drawings, and may be made of a transparent resin or glass material.

The image output unit 30 is disposed at one end of the first optical means 50, as shown in the drawings.

The image output unit 30 is a means that outputs virtual image light, which is image light corresponding to a virtual image. In this case, the virtual image refers to an image for augmented reality to be provided to a user, and may be a still image or a moving image.

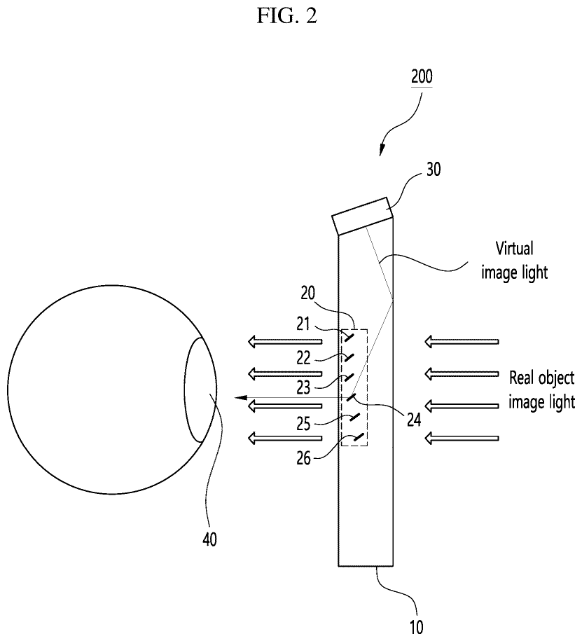

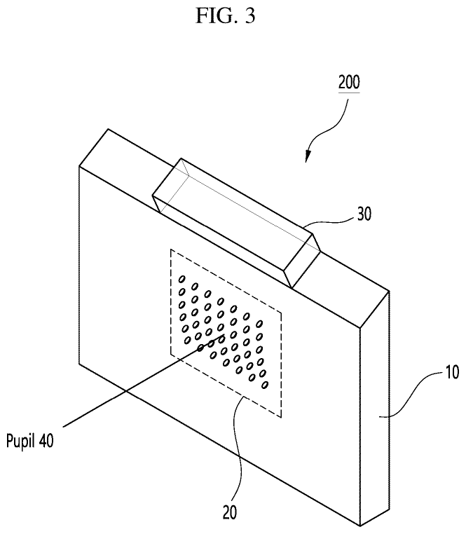

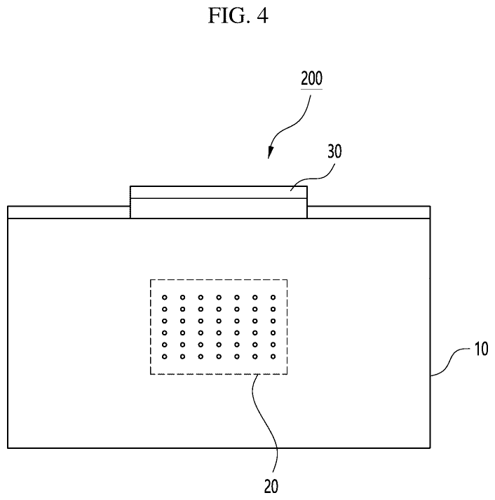

The image output unit 30 includes a display unit, such as a small liquid crystal display (LCD), organic light emitting diode (OLED), liquid crystal on silicon (LCoS), or micro-LED display, or the like, which is known in the art, that displays a virtual image. However, in the optical device 300 of the present invention, the optical conversion unit 70 is disposed in the first optical means 50, the image output unit 30 does not include an optical conversion unit that performs the same function as in FIGS. 2 to 4 described in the background art section.

Meanwhile, the image output unit 30 may further include an optical element formed of a combination of any one or more of a reflective means, a refractive means, and a diffractive means that are combined with the display unit.

This image output unit 30 itself is not a direct target of the present invention and is known in the art, so that a detailed description thereof will be omitted here.

The virtual image light may be output from the image output unit 30, reflected by total internal reflection inside the first optical means 50, and transferred to the optical conversion unit 70. In the embodiment of FIGS. 5 to 7, the virtual image light may be reflected by total internal reflection on the top surface 51 of the first optical means 50 and transferred to the optical conversion unit 70.

In this case, the surface of the image output unit 30 is disposed to be inclined to face the top surface 51 of the first optical means 50, and one end of the first optical means 50 at which the image output unit 30 is disposed may also be formed to be inclined to correspond to the inclination angle of the image output unit 30.

However, this is illustrative, and the virtual image light output from the image output unit 30 may be transferred to the optical conversion unit 70 without total internal reflection or through two or more total internal reflections. In this case, it is obvious that the shapes and inclination angles of the image output unit 30 and the first optical means 50 may have different shapes and arrangement structures.

The optical conversion unit 70 is embedded and disposed inside the first optical means 50, and is a means that transfers the virtual image light, propagating through the inside of the first optical means 50, to the first optical elements 60.

The optical conversion unit 70 may be embedded and disposed inside the first optical means 50 to face the image output unit 30, as shown in FIGS. 5 to 7.

As described above, the virtual image light output from the image output unit 30 may be reflected by total internal reflection on the top surface 51 of the first optical means 50 and transferred to the optical conversion unit 70, and the virtual image light output from the optical conversion unit 70 may be reflected by total internal reflected inside the first optical means 50 and transferred to the first optical elements 60.

In the embodiment of FIGS. 5 to 7, the virtual image light output from the optical conversion unit 70 is reflected by total internal reflection on the top surface 51 of the first optical means 50 and transferred to the first optical elements 60.

The optical conversion unit 70 is disposed inside the first optical means 50 to have an appropriate inclination angle according to the relative locations of the image output unit 30 and the first optical elements 60 based on the above optical path.

Meanwhile, the virtual image light output from the optical conversion unit 70 is image light having an intended focal length. For example, the optical conversion unit 70 may be a reflective means that reflects incident virtual image light. Preferably, the optical conversion unit 70 is a concave mirror that reflects and outputs virtual image light so that a virtual image is enlarged.

In this case, the optical conversion unit 70 is preferably a full mirror that is, for example, made of metal and has a reflectivity of 100% or a value close thereto, but may also be a half mirror that transmits part of incident light therethrough and reflects part of it therefrom.

When the optical conversion unit 70 is a reflective means, the optical conversion unit 70 may be embedded and disposed inside the first optical means 50 such that a reflective surface 71 that reflects virtual image light faces the top surface 51 of the first optical means 50, as shown in FIGS. 5 to 7.

In this case, a straight line in the vertical direction from the center of the reflective surface 71 and the top surface 51 of the first optical means 50 may be disposed to be inclined such that they are not parallel to each other.

Meanwhile, the reflective surface 71 of the optical conversion unit 70 may be formed as a curved surface. For example, the reflective surface 71 of the optical conversion unit 70 may be formed to be concave with respect to the direction of the top surface 51 of the first optical means 50, as shown in the drawings.

Meanwhile, the optical conversion unit 70 may be implemented as a collimator that converts incident virtual image light into parallel light and outputs the parallel light.

Furthermore, the optical conversion unit 70 may be formed of a refractive element or a diffractive element other than a reflective means. Alternatively, the optical conversion unit 70 may be formed of a combination of at least two or more of a reflective means, a refractive element, and a diffractive element.

Furthermore, the optical conversion unit 70 may be formed of an optical element, such as a notch filter, that selectively transmits light therethrough depending on its wavelength.

Furthermore, the surface opposite to the reflective surface 71 of the optical conversion unit 70 may be coated with a material that absorbs light without reflecting it.

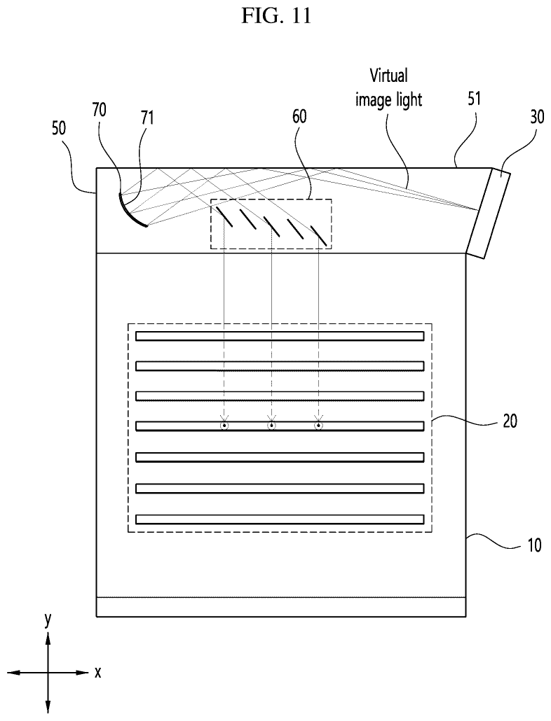

Meanwhile, the optical conversion unit 70 may be formed in the shape of a gentle “U”-shaped bar with the central portion thereof formed to be concave when viewed in direction A of FIG. 7, as shown in FIG. 11.

Meanwhile, the optical conversion unit 70 is preferably formed such that the length thereof corresponds to or is slightly longer than the length of the first optical elements 60 when viewed from a side, as shown in FIG. 7.

Meanwhile, the plurality of first optical elements 60 are embedded and disposed in the first optical means 50, and are means that output the virtual image light, transferred from the optical conversion unit 70, to the second optical means 10.

The plurality of first optical elements 60 are arranged at intervals in a first direction inside the first optical means 50.

In this case, the first direction may be a direction parallel to a virtual line segment that can be observed when the optical device 300 is placed in front of the pupil 40, as shown in FIGS. 5 to 7. In other words, the first direction may be any direction other than a direction that is parallel to a straight line in the forward direction of the pupil 40.

Furthermore, it is preferable that the first direction is a direction parallel to any one of the line segments included in a plane perpendicular to a straight line in the forward direction of the pupil 40. In the embodiment of FIGS. 5 to 7, the first direction corresponds to the x-axis direction.

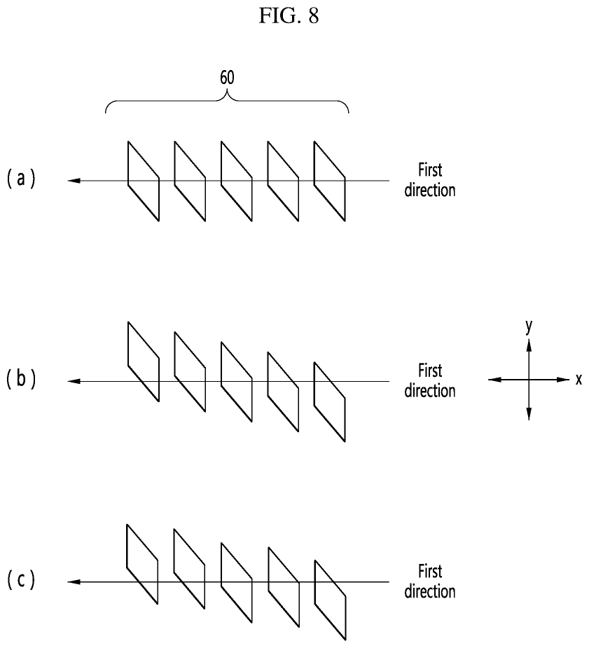

The plurality of first optical elements 60 are arranged at intervals in the first direction. However, it should be noted that they do not necessarily have to be aligned along a straight line parallel to the first direction. That is, it is sufficient if the plurality of first optical elements 60 are arranged at intervals in the first direction. This will be described with reference to FIG. 8.

FIG. 8 is a diagram illustrating the arrangement structure of the first optical elements 60.

FIG. 8 is a front view of the optical device 300 placed in front of the pupil 40, showing only the first direction and the first optical elements 60.

First, referring to FIG. 8(a), when the optical device 300 is placed in front and viewed, the centers of the plurality of respective first optical elements 60 may be spaced apart from each other so that they are aligned along a straight line parallel to the first direction (the x-axis direction).

Furthermore, as shown in FIG. 8(b), when the optical device 300 is placed in front and viewed, the centers of the plurality of respective first optical elements 60 may be spaced apart from each other so that they are aligned along a straight line having an inclination angle with respect to the first direction.

Moreover, as shown in FIG. 8(c), when the optical device 300 is placed in front and viewed, the centers of the plurality of respective first optical elements 60 may be spaced apart to be positioned on a gentle “C”-shaped curve. This is the same as shown in FIG. 6.

In this manner, it is sufficient if the plurality of first optical elements 60 are arranged at intervals in the first direction, and they do not necessarily have to be aligned along a straight line parallel to the first direction.

Meanwhile, only some of the plurality of first optical elements 60 may have such an arrangement structure.

It is obvious that in addition to such an arrangement structure, the first optical elements 60 may be arranged in different arrangement structures according to various conditions such as the relative locational relationship of the image output unit 30, the optical conversion unit 70, the second optical means 10, the second optical elements 20, and the pupil 40, the inclination angle, and the total internal reflection.

Furthermore, it is obvious that although the intervals between the plurality of first optical elements 60 may be all the same, the intervals between at least some of the plurality of first optical elements 60 may be different.

Meanwhile, the plurality of first optical elements 60 are arranged to be inclined inside the first optical means 50 so that the virtual image light output from the optical conversion unit 70 can be transferred to the second optical means 10. That is, the plurality of first optical elements 60 may be arranged to be inclined inside the first optical means 50 by taking into consideration the locations of the optical conversion unit 70 and the second optical means 10.

In the embodiment of FIGS. 5 to 7, as described above, the virtual image light output from the optical conversion unit 70 is reflected by total internal reflection on the top surface 51 of the first optical means 50 and then transferred to the plurality of first optical elements 60, and the virtual image light output from the first optical elements 60 is reflected by total internal reflection on the second surface 12 of the second optical means 10 and then transferred to the second optical elements 20.

Accordingly, in the embodiment of FIGS. 5 to 7, the plurality of first optical elements 60 may be arranged inside the first optical means 50 to have an inclination angle with respect to the first direction when the optical device 300 is placed in front of the pupil 40 and viewed and also have an inclination angle with respect to a second direction when viewed from a side by taking into consideration the above optical paths.

In this case, the second direction is the direction in which the plurality of second optical elements 20 are arranged in the second optical means 10, as will be described later.

This second direction may be a direction that is not parallel to the first direction.

In addition, the second direction may be a direction that is perpendicular to the first direction.

Furthermore, the second direction may be the direction that, when the optical device 300 for augmented reality is placed in front of the user's pupil 40, as shown in FIGS. 5 to 7, allows the virtual plane formed by the first direction and the second direction to become a two-dimensional plane that can be observed from the user's pupil 40.

Furthermore, as described above, the first direction may be a direction parallel to any one of the line segments included in a plane perpendicular to a straight line in the forward direction of the pupil 40 when the optical device 300 is placed in front of the pupil 40, in which case the second direction may be a direction parallel to any one of the line segments that are included in a plane perpendicular to the straight line in the forward direction of the pupil 40 and that are perpendicular to the first direction.

To this end, the top surface 13 of the second optical means 10 may be formed to be inclined when viewed from a side, and the first optical means 50 may be disposed on the top surface 13 of the second optical means 10.

In this case, each of the plurality of first optical elements 60 may be arranged to be closer to the top surface 51 of the first optical means 50 as it is located farther away from the image output unit 30, as shown in FIG. 8(b) or 8(c), in order not to block the virtual image light that is output from the image output unit 30 and transferred to other first optical elements 60.

Meanwhile, the plurality of first optical elements 60 may each be formed in, for example, a rectangular shape, and it is preferable that the length of each element in the widthwise direction thereof is formed to correspond to the length of the image output unit 30 in the widthwise direction thereof.

Furthermore, the plurality of first optical elements 60 may be formed to have a height smaller than the average pupil size of humans, i.e., 8 mm or less, more preferably 4 mm or less, when viewed from a side.

Furthermore, it is preferable that the plurality of first optical elements 60 are reflective means that reflect incident light.

In this case, it is preferable that the plurality of first optical elements 60 are full mirrors that are, for example, made of metal and have a reflectivity of 100% or a high value close thereto, but may also be half mirrors that transmit part of incident light therethrough and reflect part of it therefrom.

Furthermore, the plurality of first optical elements 60 may be formed of any one of refractive elements, diffractive elements, and holographic optical elements, or a combination thereof.

The second optical means 10 is a means that transfer the real object image light, output from a real object present in the real world, to the pupil 40 of the user's eye by transmitting the real object image light therethrough. Furthermore, the second optical means 10 also serves as a waveguide through which the virtual image light output from the first optical elements 60 propagates via the inside of the second optical means 10.

The second optical means 10 may also be made of a transparent resin or glass material.

The second optical means 10 has a first surface 11 through which virtual image light and real object image light are output toward the user's pupil 40, a second surface 12 which faces the first surface 11 and on which real object image light is incident, and a third surface 13 on which the first optical means 50 is disposed.

The virtual image light transferred to the second optical means 10 through the image output unit 30, the optical conversion unit 70, and the first optical elements 60 is transferred to the pupil 40 through the first surface 11 of the second optical means 10, and the real object image light is transmitted through the second surface 12 and first surface 11 of second optical means 10 and then transferred to the pupil 40. Accordingly, the user may receive the virtual image light and the real object image light at the same time, and thus can receive an augmented reality service.

The plurality of second optical elements 20 are embedded inside the second optical means 10, and are means that provide a virtual image to the user by transferring the virtual image light, propagating through the inside of the second optical means 10, to the pupil 40 of the user's eye.

The plurality of second optical elements 20 are arranged at intervals in the second direction.

In this case, the second direction may be a direction that is not parallel to the first direction as described above, and may also be a direction that is perpendicular to the first direction.

Furthermore, as shown in FIGS. 5 to 7, the second direction may be the direction that, when the optical device 300 is placed in front of the user's pupil 40, allows the virtual plane formed by the first direction and the second direction to become a two-dimensional plane that can be observed from the user's pupil 40.

Furthermore, in the case where the optical device 300 is placed in front of the pupil 40, when the first direction is a direction parallel to any one of the line segments included in a plane perpendicular to a straight line in the forward direction of the pupil 40, the second direction may be a direction parallel to any one of the line segments that are included in a plane perpendicular to the straight line in the forward direction of the pupil 40 and that are perpendicular to the first direction.

For example, in the embodiment of FIGS. 5 to 7, the first direction is the x-axis direction, and thus, the second direction may correspond to the y axis perpendicular to the first direction among the line segments included in the plane that is perpendicular to the z axis, which is a straight line in the forward direction of the pupil 40, while being perpendicular to the x axis. Accordingly, the virtual plane formed by the first direction (the x-axis direction) and the second direction (the y-axis direction) becomes a two-dimensional x-y plane that is perpendicular to the z axis.

This two-dimensional plane does not necessarily have to be perpendicular to the z axis, and it does not matter if the two-dimensional plane is slightly rotated around the x axis or y axis as long as it can be observed from the user's pupil 40.

Furthermore, it should be noted that the plurality of second optical elements 20 being “spaced apart in the second direction” means that it is sufficient for the plurality of second optical elements 20 to be spaced apart from each other in the second direction, as previously described in conjunction with the first optical elements 60, but does not mean that they have to be aligned along a straight line parallel to the second direction.

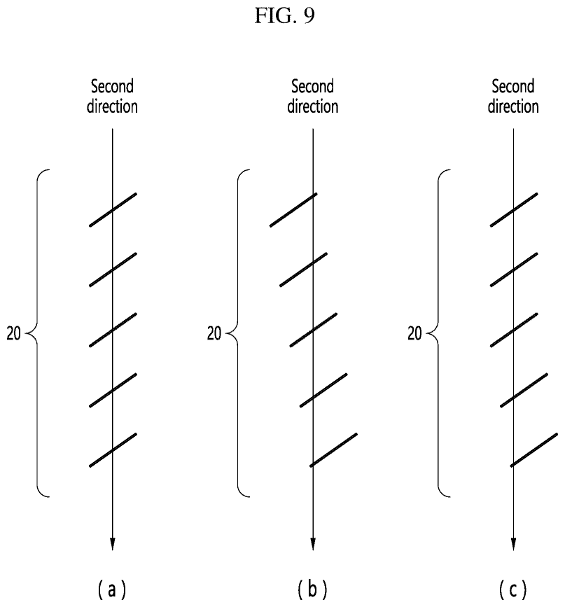

FIG. 9 is a diagram illustrating the arrangement structure of the second optical elements 20.

FIG. 9 is a side view when the optical device 300 is placed in front of the pupil 40, only showing the second direction and the second optical elements 20.

Referring to FIG. 9(a), the plurality of second optical elements 20 may be spaced apart from each other so that when the optical device 300 is placed in front of the pupil 40 and viewed from a side, the centers thereof may be aligned along a straight line parallel to the second direction (the y-axis direction).

Furthermore, as shown in FIG. 9(b), the plurality of second optical elements 20 may be spaced apart from each other so that the centers thereof are aligned along a straight line having an inclination angle with respect to the second direction (the y-axis direction) when the optical device 300 is placed in front of the pupil 40 and viewed from the side.

Furthermore, as shown in FIG. 9(c), the plurality of second optical elements 20 may be spaced apart from each other so that the centers thereof are positioned on a gentle “C”-shaped curve when the optical device 300 is placed in front of the pupil 40 and viewed from the side. This is the same as that shown in FIG. 7.

In this case, only some of the plurality of second optical elements 20 may have such an arrangement structure.

It is obvious that in addition to such an arrangement structure, the second optical elements 20 may be arranged in different arrangement structures according to various conditions such as the relative locational relationship of the image output unit 30, the optical conversion unit 70, the first optical means 50, the first optical elements 60, the second optical means 10 and the pupil 40, the inclination angle, and the total internal reflection.

Furthermore, it is obvious that although the intervals between the plurality of second optical elements 20 may be all the same, the intervals between at least some of the plurality of second optical elements 20 may be different.

Meanwhile, the plurality of second optical elements 20 may each be formed in the shape of a bar extending in the first direction, i.e., the x-axis direction, as shown in the drawings.

Furthermore, each of the plurality of second optical elements 20 may be arranged to be inclined inside the second optical means 10 so that the virtual image light propagating through the inside of the second optical means 10 can be transferred to the pupil 40. In this case, the plurality of second optical elements 20 may each be arranged inside the second optical means 10 at an appropriate inclination angle by taking into consideration the relative locations of the first optical means 50, the first optical elements 60, and the pupil 40.

In the embodiment of FIGS. 5 to 7, the virtual image light output from the first optical elements 60 is reflected by total internal reflection on the second surface 12 of the second optical means 10 and transferred to the plurality of second optical elements 20. Accordingly, by taking into consideration this optical path, each of the plurality of second optical elements 20 may be arranged at an inclination angle inside the second optical means 10 so that the virtual image light, which is reflected by total internal reflection on the second surface 12 of the second optical means 10 and then transferred, can be transferred to the pupil 40.

In this case, each of the plurality of second optical elements 20 may be arranged to be closer to the second surface 12 of the second optical means 10 as it is located farther away from the first optical elements 60, as shown in FIG. 9(b) or 9(c), in order not to block the virtual image light that is output from the first optical elements 60 and transferred to other second optical elements 20.

Meanwhile, the plurality of second optical elements 20 may be formed to have a height smaller than the average pupil size of humans, i.e., 8 mm or less, more preferably 4 mm or less, when viewed from the front, as shown in FIG. 6.

By this, the depth of field for the light incident on the pupil 40 may be made considerably deep. Accordingly, there is obtained the pinhole effect that makes a user recognize that a virtual image is always in focus regardless of whether the user changes the focal length for the real world while viewing it.

However, the diffraction phenomenon increases when the height is excessively small, so that it is preferable to make the height larger than, for example, 0.3 mm.

Furthermore, it is preferable that the plurality of second optical elements 20 are reflective means that reflect incident light.

Furthermore, the plurality of second optical elements 20 are preferably full mirrors that are made of, for example, a metal material and have a reflectivity of 100% or a high value close thereto, but may also be half mirrors that transmit part of incident light therethrough and reflect part of it therefrom.

Furthermore, the plurality of second optical elements 20 may be formed of any one of refractive elements, diffractive elements, and holographic optical elements, or a combination thereof.

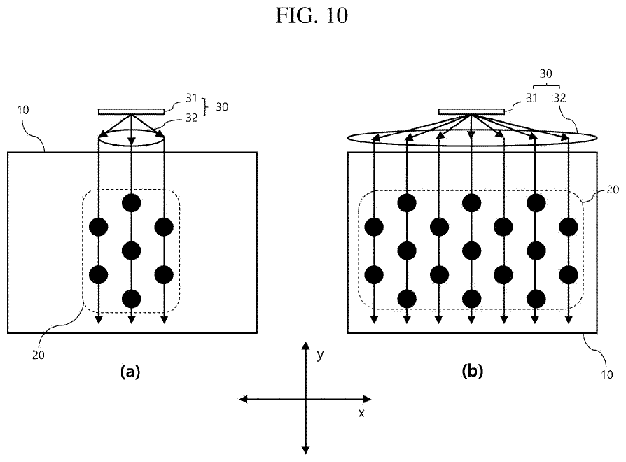

Next, the principle of expansion of an eye box by the optical device 300 will be described with reference to FIGS. 10 and 11.

FIG. 10 is a diagram illustrating an eye box in the first direction (the x-axis direction) in the conventional optical device 200 of FIGS. 2 to 4, and is a front view when the optical device 200 is placed in front of the pupil 40.

Referring to the optical device 200 of FIG. 10(a), the virtual image light output from one point of a display unit 31 is output to the optical means 10 via the optical conversion unit 32, reflected by reflective units 20, and then transferred to the pupil 40. In this case, the eye box in the x-axis direction, i.e., the first direction, is determined by the length of the optical conversion unit 32 in the first direction.

In the optical device 200 of FIG. 10(b), all other conditions are the same, but the length of the optical conversion unit 32 in the first direction is longer than that of FIG. 10(a). Accordingly, it can be seen that more reflective units 20 are also arranged along the x-axis direction (the first direction) in accordance with the length of the optical conversion unit 32, and thus, the eye box in the first direction is wider than that of FIG. 10(a).

In this manner, it can be seen that in the conventional optical device 200 such as that shown in FIGS. 2 to 4, the eye box in the first direction (the x-axis direction) depends on the length of the optical conversion unit 32 included in the image output unit 30. However, when the length of the optical conversion unit 32 is increased, problems arise in that the form factor is increased, the design becomes complicated, and the manufacturing process also becomes complicated.

Meanwhile, in FIG. 10, the eye box in the y-axis direction, which is the vertical axis, is determined by the number of reflective units 20 arranged in the y-axis direction.

FIG. 11 is a diagram illustrating an eye box in the first direction in the optical device 300 of FIGS. 5 to 7, and is a drawing when the optical device 300 is viewed in the direction indicated by A of FIG. 7.

Referring to FIG. 11, the virtual image light output from one point of the display unit, i.e., the image output unit 30, is reflected by total internal reflection on the top surface 51 of the first optical means 50 and transferred to the optical conversion unit 70. Then, the virtual image light output from the optical conversion unit 70 is reflected by total internal reflection again on the top surface 51 of the first optical means 50 and transferred to the first optical elements 60. Thereafter, the first optical elements 60 output the virtual image light toward the second surface 12 of the second optical means 10.

Therefore, it can be seen that the virtual image light output from the image output unit 30 is transferred to the plurality of first optical elements 60 via the optical conversion unit 70 by total internal reflection on the top surface 51 of the first optical means 50, so that the virtual image light is replicated in the first direction (the x-axis direction), and thus, the eye box in the first direction, i.e., the x-axis direction, is expanded.

In FIG. 11, the eye box in the y-axis direction, which is the vertical axis, is determined by the number of second optical elements 20 that are arranged in the y-axis direction. Accordingly, it can be seen that while the eye box in the y-axis direction, which is the vertical axis, is kept the same, the eye box in the first direction, which is the horizontal axis, i.e., the x-axis direction of the optical device 300 of FIG. 11 is wider than the eye box in the first direction of the optical device 200 of FIG. 10.

Moreover, in the optical device 300 of FIG. 11, the optical conversion unit 70 is embedded inside the first optical means 50, so that there is no need to use the optical conversion unit in the image output unit 30. Accordingly, the overall form factor of the optical device 300 may be made small, so that the two-dimensional eye box in the x-axis and y-axis directions can be expanded and also there is provided the optical device 300 that can be made small and lightweight.

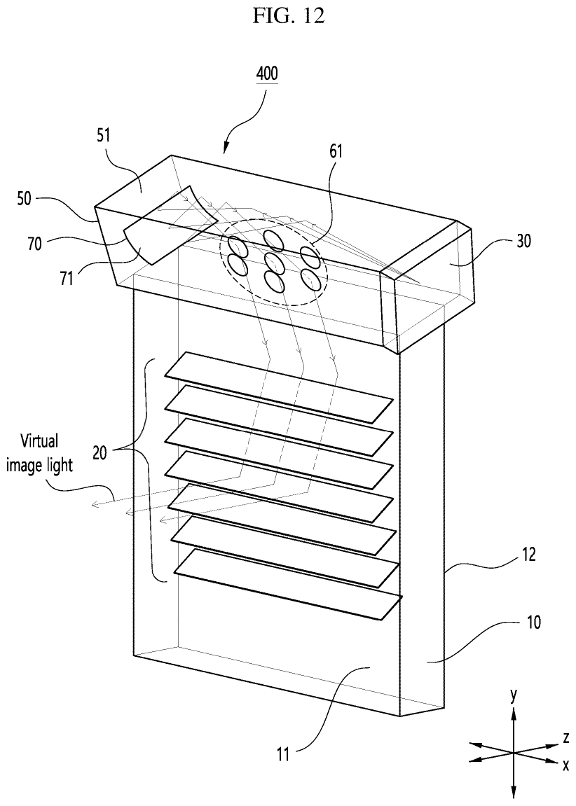

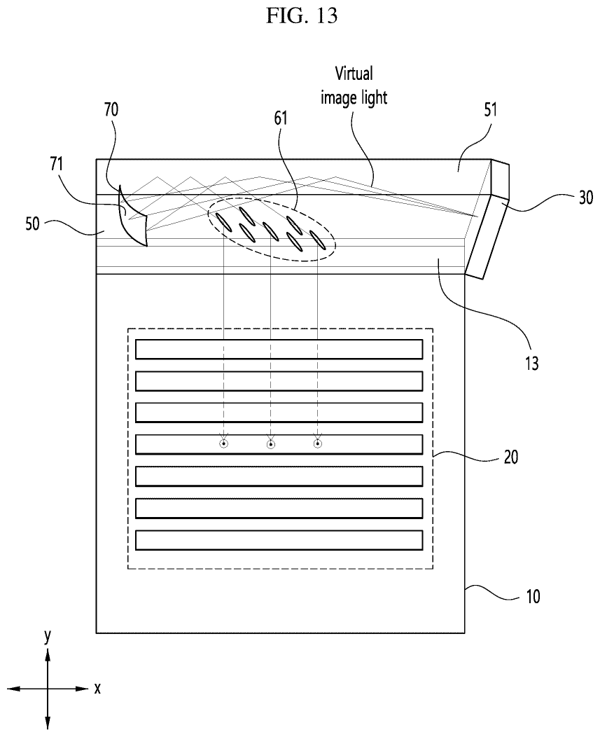

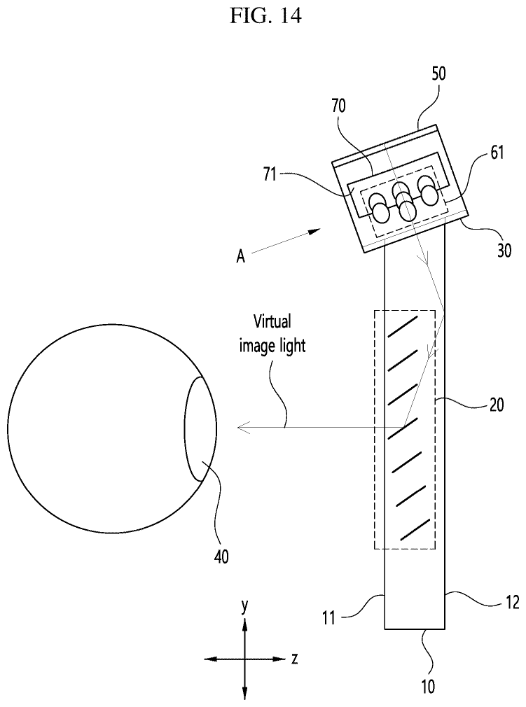

FIGS. 12 to 14 are diagrams illustrating an optical device 400 according to a modification of the first embodiment of the present invention, wherein FIG. 12 is a perspective view, FIG. 13 is a front view, and FIG. 14 is a side view.

The optical device 400 of FIGS. 12 to 14 has the same basic principle as the optical device 300 of FIGS. 5 to 7, except that each of the plurality of first optical elements 60 is formed of a plurality of optical modules 61 in the shape of pinpoints.

That is, in the optical device 400, each of the plurality of first optical elements 60 may be formed of the plurality of optical modules 61 that are arranged to be spaced apart from each other and appear in an array form when the optical device 400 is placed in front of the pupil 40 and viewed from a side.

Each of the plurality of optical modules 61 may be formed in a size smaller than the size of a human pupil, i.e., 8 mm or less, preferably 4 mm or less, in order to obtain the pinhole effect by increasing the depth of field.

The size of the plurality of optical modules 61 is defined to mean the maximum length between any two points on the edge boundary of each of the optical modules 61.

Furthermore, the size of each of the optical modules 61 may be the maximum length between any two points on the edge boundary line of the projection of each of the optical modules 61 onto a plane that includes the center of the pupil 40 while being perpendicular to the straight line between the pupil 40 and the optical module 61.

However, the diffraction phenomenon increases when the size is excessively small, so that it is preferable to make it larger than, for example, 0.3 mm.

Furthermore, the shape of each of the plurality of optical modules 61 may be circular.

Furthermore, the optical modules 61 may each be formed in an oval shape to appear circular when viewed from the pupil 40.

Except for these, all the components of the optical device 400 are the same as those of the optical device 300 described above, so that detailed descriptions thereof will be omitted.

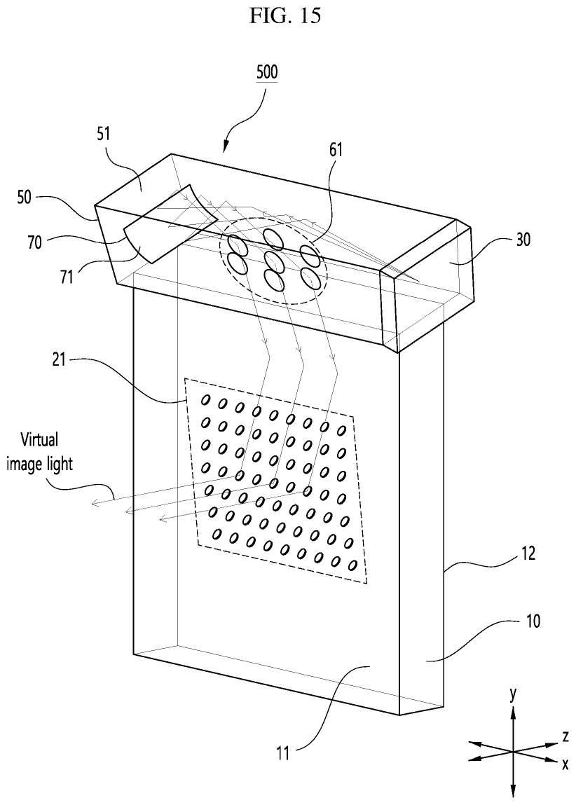

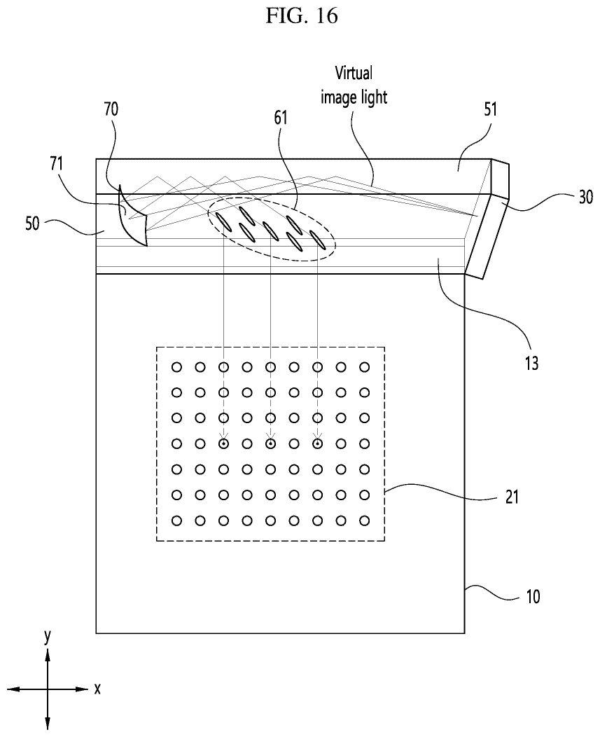

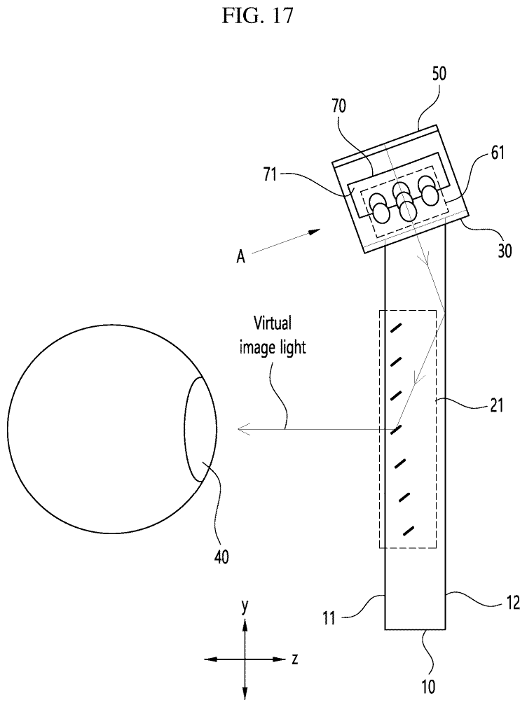

FIGS. 15 to 17 are diagrams illustrating an optical device 500 according to another modification of the first embodiment of the present invention, wherein FIG. 15 is a perspective view, FIG. 16 is a front view, and FIG. 17 is a side view.

The optical device 500 of FIGS. 15 to 17 is the same as the optical device 400 of FIGS. 12 to 14, except that each of a plurality of second optical elements 20 is formed of a plurality of optical modules 21 in the shape of pinpoints.

That is, each of the plurality of second optical elements 20 is formed of the plurality of optical modules 21 that are arranged to be spaced apart from each other and appear in an array form when viewed from the front, as shown in the drawings.

Since the size and shape of these optical modules 21 are the same as those of the optical modules 61 described above in conjunction with FIGS. 12 to 14, detailed descriptions thereof will be omitted.

However, the sizes of the optical module 21 and the optical module 61 do not have to be the same, but they may be different.

Meanwhile, it is obvious that although not shown in the drawings, the plurality of second optical elements 20 may also be formed of a plurality of pinpoint-shaped optical modules 21 in the optical device 300 of FIGS. 5 to 7.

### SECOND EMBODIMENT

Next, a second embodiment according to the present invention will be described.

The second embodiment according to the present invention is similar to the first embodiment described above, but is characterized by using a diffractive optical element.

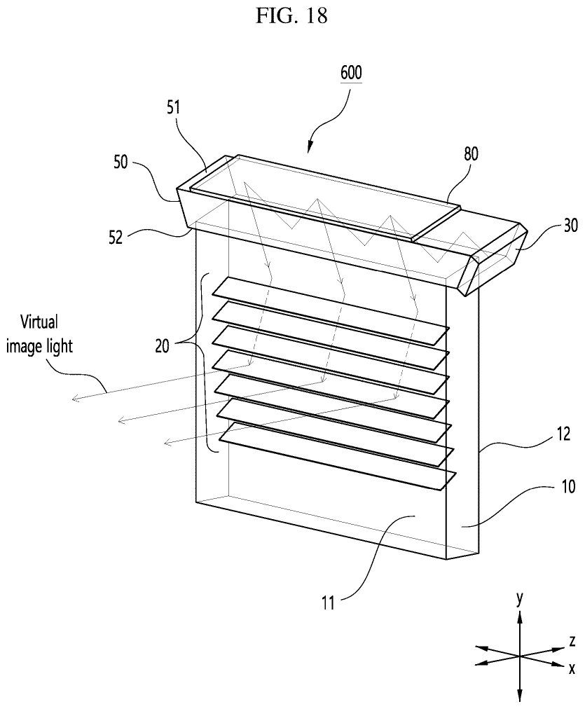

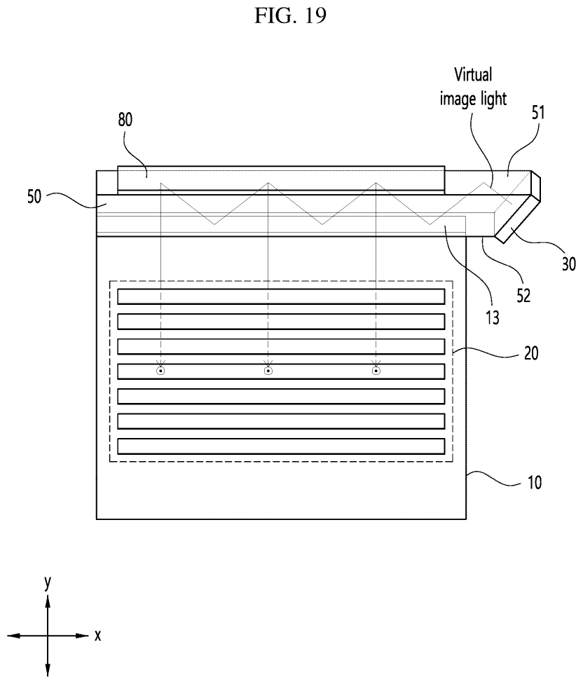

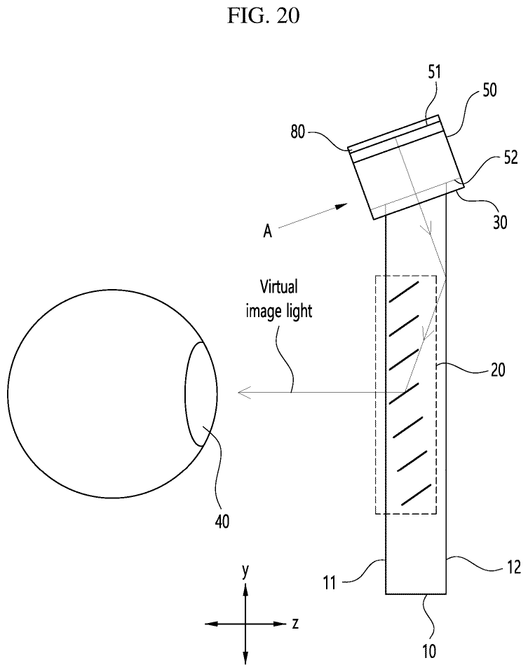

FIGS. 18 to 20 are diagrams illustrating an optical device 600 for augmented reality providing an expanded eye box according to the second embodiment of the present invention, wherein FIG. 18 is a perspective view, FIG. 19 is a front view, and FIG. 20 is a side view.

However, for ease of illustration, an image output unit 30 is shown as transparent in FIG. 20.

Referring to FIGS. 18 to 20, the optical device 600 for augmented reality providing an expanded eye box (hereinafter simply referred to as the “optical device 600”) includes a first optical means 50, a first optical element 80, a second optical means 10, and second optical elements 20.

The first optical means 50 is a means through which the virtual image light output from the image output unit 30 propagates, and serves as a waveguide.

The first optical element 80 is disposed on/in the first optical means 50 as will be described below.

In FIGS. 18 to 20, the first optical element 80 is disposed on the top surface 51 of the first optical means 50.

The first optical means 50 may have an approximately rectangular hexahedral shape, as shown in the drawings, and may be made of a transparent resin or glass material.

The image output unit 30 is disposed at one end of the first optical means 50, as shown in the drawings.

The image output unit 30 is a means that outputs virtual image light, which is image light corresponding to a virtual image. In this case, the virtual image refers to an image for augmented reality to be provided to a user, and may be a still image or a moving image.

The image output unit 30 includes a display unit, such a small liquid crystal display (LCD), organic light emitting diode (OLED), liquid crystal on silicon (LCoS), or micro-LED display, or the like, which is known in the art, that displays a virtual image, and an optical conversion unit (not shown) that transfers the virtual image light, output from the display unit, to the first optical element 80.

As described in the background art section, the optical conversion unit is a means that allows virtual image light to be output according to an intended optical path and focal length, and may be an optical element such as a concave mirror that outputs incident virtual image light by reflecting it in order to enlarge a virtual image or a collimator that converts incident light into parallel light and outputs the parallel light.

The image output unit 30 may include a combination of any one or more of a reflective means, a refractive means, and a diffractive means combined with the display unit and the optical conversion unit, in addition to the display unit and the optical conversion unit.

This image output unit 30 itself is not a direct target of the present invention and is known in the art, so that a detailed description thereof will be omitted here.

The virtual image light may be output from the image output unit 30, reflected by total internal reflection inside the first optical means 50, and transferred to the first optical element 80. In the embodiment of FIGS. 18 to 20, the virtual image light may be reflected by total internal reflection on the top surface 51 and bottom surface 52 of the first optical means 50 and transferred to the first optical element 80.

In this case, the surface of the image output unit 30 is disposed to be inclined to face the top surface 51 of the first optical means 50, and one end of the first optical means 50 at which the image output unit 30 is disposed may also be formed to be inclined to correspond to the inclination angle of the image output unit 30.

However, this is illustrative, and the virtual image light output from the image output unit 30 may be transferred directly to the first optical element 80 without total internal reflection. In this case, it is obvious that the shapes and inclination angles of the image output unit 30 and the first optical means 50 may have different shapes and arrangement structures.

The first optical element 80 is disposed on the first optical means 50, and functions to output the virtual image light, propagating through the inside of the first optical means 50, to the second optical means 10.

The first optical element 80 may be formed in the shape of a thin plate extending in a first direction and disposed on the first optical means 50, as shown in the drawings. In this case, the normal line of the thin plate may be disposed to face the second surface 20 of the second optical means 10 as will be described later.

In FIGS. 18 to 20, the first optical element 80 is disposed on the top surface 51 of the first optical means 50, i.e., the outside of the top surface 51. However, this is illustrative, and the first optical element 80 may be disposed on the inside of the top surface 51.

Alternatively, as in the embodiment to be described below, the first optical element 80 may be disposed on the outside or inside of the bottom surface 52 of the first optical means 50. Alternatively, the first optical element 80 may be disposed inside the first optical means 50.

The first optical means 50 extends in the first direction. In this case, the “first direction” may be a direction parallel to a virtual line segment that can be observed when the optical device 300 is placed in front of the pupil 40, as shown in FIGS. 18 to 20. In other words, the first direction may be any direction other than a direction parallel to a straight line in the forward direction of the pupil 40.

Furthermore, it is preferable that the first direction is a direction parallel to any one of the line segments included in a plane perpendicular to a straight line in the forward direction of the pupil 40. In the embodiment of FIGS. 18 to 20, the first direction corresponds to the x-axis direction.

Meanwhile, in the second embodiment of the present invention, the first optical element 80 is characterized by being implemented as a diffractive optical element. A diffractive optical element (DOE) refers to an optical element that refracts or reflects incident light through a diffraction phenomenon. That is, a diffractive optical element is an optical element that provides various optical functions by utilizing the phenomenon of diffraction of light.

A diffractive optical element has the advantages of enabling a point-to-point image without aberration and a flat-panel structure and enabling aberration control such as asphericity. Furthermore, a diffractive optical element has a considerably thin thickness of several μm, but plays similar roles to those of a general lens, prism, and mirror having a thickness of several mm, so that it is advantageous in reducing the volume and weight of an optical system.

In particular, due to the wavelength-dependent nature of the diffraction phenomenon, a diffractive optical element acts as a refractive or reflective element only for light of a wavelength band that matches the design wavelength band of a nanostructure, and serves as a window that simply transmits light therethrough for other wavelength bands.

Diffractive optical elements may be divided into reflective diffractive optical elements and transmissive diffractive optical elements. A reflective diffractive element refers to a diffractive element that utilizes the property of reflecting light incident from a specific direction and location. A transmissive diffractive element refers to a diffractive element that utilizes the property of transmitting therethrough light incident from a specific direction and location.

In the present invention, the first optical element 80 is implemented using such a diffractive optical element, so that the virtual image light transferred from the image output unit 30 can be replicated in the first direction to expand the eye box and also incident virtual image light can be transferred to the second optical means 10.

The basic configurations or characteristics of such a diffractive optical element, reflective diffractive optical element, and transmissive diffractive optical element themselves are known in the art, so that detailed descriptions thereof will be omitted here.

When this diffractive optical element is employed, there are advantages in that more brightness of a perspective image can be achieved by increasing transparency and an optical device for augmented reality having better aesthetics, for which the appearance of a product is similar to that of ordinary glasses, can be provided because an optical synthesizer structure is not visible from the outside.

The first optical element 80 is disposed on the first optical means 50 at an appropriate inclination angle so that virtual image light can be transferred to the second optical means 10.

In the embodiment of FIGS. 18 to 20, the virtual image light output from the first optical element 80 implemented as a diffractive optical element is reflected by total internal reflection on the second surface 12 of the second optical means 10 and then transferred to the second optical element 20.

Accordingly, in the embodiment of FIGS. 18 to 20, by taking into consideration the above optical path, the first optical element 80 may be disposed on the outside of the top surface 51 of the first optical means 50 to have an inclination angle with respect to the second direction, as shown in FIG. 20, when the optical device 300 is placed in front of the pupil 40 and viewed from a side.

In this case, the second direction is the direction in which the plurality of second optical elements 20 are arranged in the second optical means 10, as will be described later.

This second direction may be a direction that is not parallel to the first direction.

Furthermore, the second direction may be a direction that is perpendicular to the first direction.

Furthermore, the second direction may be the direction that, when the optical device 600 for augmented reality is placed in front of the user's pupil 40, as shown in FIGS. 18 to 20, allows the virtual plane formed by the first direction and the second direction to become a two-dimensional plane that can be observed from the user's pupil 40.

Furthermore, as described above, the first direction may be a direction parallel to any one of the line segments included in a plane perpendicular to a straight line in the forward direction of the pupil 40 when the optical device 600 is placed in front of the pupil 40, in which case the second direction may be a direction parallel to any one of the line segments that are included in a plane perpendicular to the straight line in the forward direction of the pupil 40 and that are perpendicular to the first direction.

To this end, as shown in FIG. 20, the top surface 13 of the second optical means 10 may be formed to be inclined when viewed from the side, and the first optical means 50 may be disposed on the top surface 13 of the second optical means 10.

The first optical element 80 may be, for example, a thin plate shape having a rectangular surface. In this case, it is preferable that the length of the first optical element 80 in the widthwise direction thereof is formed to correspond to the length of the image output unit 30 in the widthwise direction thereof when viewed from a side.

Furthermore, in the first optical element 80, the surface thereof through which virtual image light is incident and is output is formed to extend in the first direction, thereby expanding the eye box for the virtual image light in the first direction.

The second optical means 10 is a means that transfers the real object image light, output from a real object present in the real world, to the pupil 40 of the user's eye by transmitting the real object image light therethrough. Furthermore, the second optical means 10 also serves as a waveguide through which the virtual image light transferred from the first optical element 80 propagates via the inside of the second optical means 10.

The second optical means 10 may also be made of a transparent resin or glass material.

The second optical means 10 has a first surface 11 through which virtual image light and real object image light are output toward the user's pupil 40, a second surface 12 which faces the first surface 11 and on which real object image light is incident, and a third surface 13 on which the first optical means 50 is disposed.

The virtual image light transferred to the second optical means 10 through the image output unit 30 and the first optical element 80 is transferred to the pupil 40 through the first surface 11 of the second optical means 10, and the real object image light is transmitted through the second surface 12 and first surface 11 of second optical means 10 and then transferred to the pupil 40. Accordingly, the user may receive the virtual image light and the real object image light at the same time, and thus can receive an augmented reality service.

The plurality of second optical elements 20 are embedded and disposed inside the second optical means 10, and are means that provide a virtual image to the user by transferring the virtual image light, propagating through the inside of the second optical means 10, to the pupil 40 of the user's eye.

The plurality of second optical elements 20 are arranged at intervals in the second direction, and real object image light is transferred to the pupil 40 through the spaces generated by the intervals between the second optical elements 20.

In this case, the second direction may be a direction that is not parallel to the first direction as described above. Furthermore, it is preferable that the second direction is a direction that is perpendicular to the first direction.

Furthermore, as shown in FIGS. 18 to 20, the second direction may be the direction that, when the optical device 600 is placed in front of the user's pupil 40, allows the virtual plane formed by the first direction and the second direction to become a two-dimensional plane that can be observed from the user's pupil 40.

Furthermore, in the case where the optical device 600 is placed in front of the pupil 40, when the first direction is a direction parallel to any one of the line segments included in a plane perpendicular to a straight line in the forward direction of the pupil 40, the second direction may be a direction parallel to any one of the line segments that are included in a plane perpendicular to the straight line in the forward direction of the pupil 40 and that are perpendicular to the first direction.

For example, in the embodiment of FIGS. 18 to 20, the first direction is the x-axis direction, and thus, the second direction may correspond to the y axis perpendicular to the first direction among the line segments included in the plane that is perpendicular to the z axis, which is a straight line in the forward direction of the pupil 40, while being perpendicular to the x axis. Accordingly, the virtual plane formed by the first direction (the x-axis direction) and the second direction (the y-axis direction) becomes a two-dimensional x-y plane that is perpendicular to the z axis.

This two-dimensional plane does not necessarily have to be perpendicular to the z axis, and it does not matter if the two-dimensional plane is slightly rotated around the x axis or y axis as long as it can be observed from the user's pupil 40.

Furthermore, it should be noted that the plurality of second optical elements 20 being “spaced apart in the second direction” means that it is sufficient for the plurality of second optical elements 20 to be spaced apart from each other in the second direction, but does not mean that they have to be aligned along a straight line parallel to the second direction.

Meanwhile, the arrangement structure of the second optical elements 20 is the same as in FIG. 9 of the first embodiment, so that a detailed description thereof will be omitted.

Furthermore, it is obvious that although the intervals between the plurality of second optical elements 20 may be all the same, the intervals between at least some of the plurality of second optical elements 20 may be different.

Meanwhile, the plurality of second optical elements 20 may each be formed in the shape of a thin plate extending in the first direction, i.e., the x-axis direction, as shown in the drawings.

Furthermore, each of the plurality of second optical elements 20 may be arranged to be inclined inside the second optical means 10 so that the virtual image light propagating through the inside of the second optical means 10 can be transferred to the pupil 40. In this case, the plurality of second optical elements 20 may be arranged inside the second optical means 10 at an appropriate inclination angle by taking into consideration the relative locations of the first optical means 50, the first optical element 80, and the pupil 40.

In the embodiment of FIGS. 18 to 20, the virtual image light transferred from the first optical element 80 is reflected by total internal reflection on the second surface 12 of the second optical means 10 and transferred to the plurality of second optical elements 20. Accordingly, by taking into consideration this optical path, each of the plurality of second optical elements 20 may be arranged at an inclination angle inside the second optical means 10 so that the virtual image light, which is reflected by total internal reflection on the second surface 12 of the second optical means 10 and then transferred, can be transferred to the pupil 40.

In this case, each of the plurality of second optical elements 20 may be arranged to be closer to the second surface 12 of the second optical means 10 as it is located farther away from the first optical element 80, as shown in FIG. 9(b) or 9(c), in order not to block the virtual image light that is output from the first optical element 80 and transferred to other second optical elements 20.

Meanwhile, the plurality of second optical elements 20 may be formed to have a height smaller than the average pupil size of humans, i.e., 8 mm or less, more preferably 4 mm or less, when viewed from the front, as shown in FIG. 19.

By this, the depth of field for the light incident on the pupil 40 may be made considerably deep. Accordingly, there is obtained the pinhole effect that makes a user recognize that a virtual image is always in focus regardless of whether the user changes the focal length for the real world while viewing it.

However, the diffraction phenomenon increases when the height is excessively small, so that it is preferable to make the height larger than, for example, 0.3 mm.

Furthermore, it is preferable that the plurality of second optical elements 20 are reflective means that reflect incident light.

Furthermore, the plurality of second optical elements 20 are preferably full mirrors that are made of, for example, a metal material and have a reflectivity of 100% or a high value close thereto, but may also be half mirrors that transmit part of incident light therethrough and reflect part of it therefrom.

Furthermore, the plurality of second optical elements 20 may be formed of any one of refractive elements, diffractive elements, and holographic optical elements, or a combination thereof.

Meanwhile, in the optical device 300 of FIGS. 18 to 20, a holographic optical element (HOE) may be used instead of the diffractive optical element as the first optical element 80. This also applies to all embodiments to be described below.

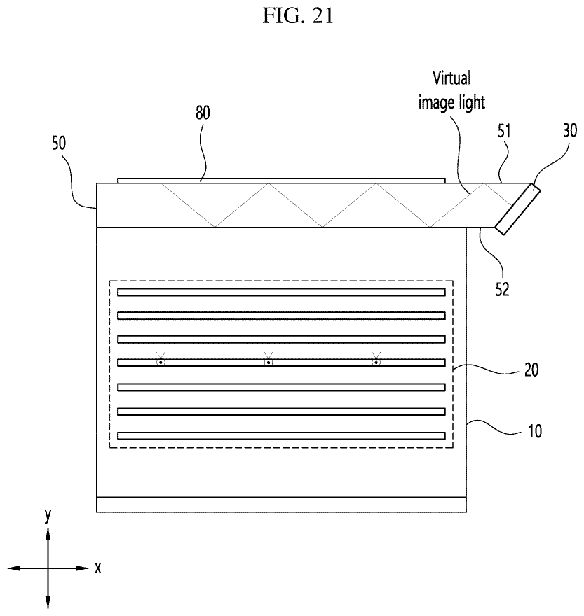

Next, the principle of expansion of an eye box by the optical device 600 will be described with reference to FIGS. 10 and 21.

FIG. 10 is a diagram illustrating an eye box for the first direction (the x-axis direction) in the conventional optical device 200 of FIGS. 2 to 4, and is a front view when the optical device 200 is placed in front of the pupil 40.

Referring to the optical device 200 of FIG. 10(a), the virtual image light output from one point of the display unit 31 is output to the optical means 10 via the optical conversion unit 32, reflected by the reflective unit 20, and transferred to the pupil 40. In this case, the eye box in the x-axis direction, i.e., the first direction, is determined by the length of the optical conversion unit 32 in the first direction.

In the optical device 200 of FIG. 10(b), all conditions are the same, except that the length of the optical conversion unit 32 in the first direction is longer than that of FIG. 10(a). Accordingly, it can be seen that more elements of the reflective unit 20 are also arranged along the x-axis direction (the first direction) in accordance with the length of the optical conversion unit 32, and thus, the eye box in the first direction becomes wider than that of FIG. 10(a).

In this manner, it can be seen that in the conventional optical device 200 such as that shown in FIGS. 2 to 4, the eye box in the first direction (the x-axis direction) depends on the length of the optical conversion unit 32 included in the image output unit 30. However, when the length of the optical conversion unit 32 is increased, problems arise in that the form factor is increased, the design becomes complicated, and the manufacturing process also becomes complicated.

Meanwhile, the eye box in the y-axis direction, which is the vertical axis in FIG. 10, is determined by the number of elements of the reflective unit 20 that are arranged in the y-axis direction.

FIG. 21 is a diagram illustrating an eye box in the first direction in the optical device 600 of FIGS. 18 to 20, and is a drawing when viewed in the direction indicated by A of FIG. 20.

Referring to FIG. 21, the virtual image light output from one point of the image output unit 30 is reflected by total internal reflection on the top surface 51 and bottom surface 52 of the first optical means 50 and transferred to the first optical element 80. Thereafter, the first optical element 80 outputs the virtual image light toward the second surface 12 of the second optical means 10.

That is, it can be seen that the virtual image light output from the image output unit 30 is reflected by total internal reflection on the top surface 51 and bottom surface 52 of the first optical means 50 and transferred to the first optical element 80, so that the virtual image light is replicated in the first direction (the x-axis direction), and thus, the eye box in the first direction, i.e., the x-axis direction, is expanded.

Also in FIG. 21, the eye box in the y-axis direction, which is the vertical axis, is determined by the number of second optical elements 20 that are arranged in the y-axis direction. Accordingly, it can be seen that while the eye box in the y-axis direction, which is the vertical axis, is kept the same, the eye box in the x-axis direction, which is the horizontal axis, i.e., the first direction, is wider in the optical device 600 of FIG. 21 than in the optical device 200 of FIG. 10.

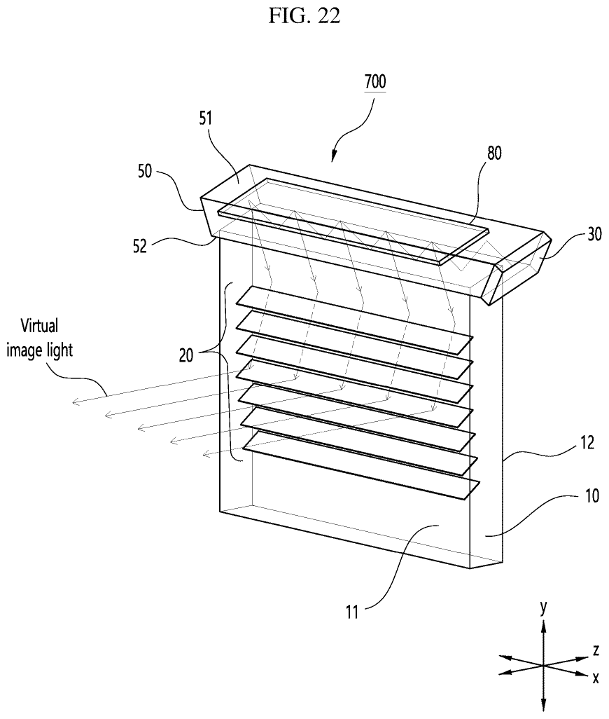

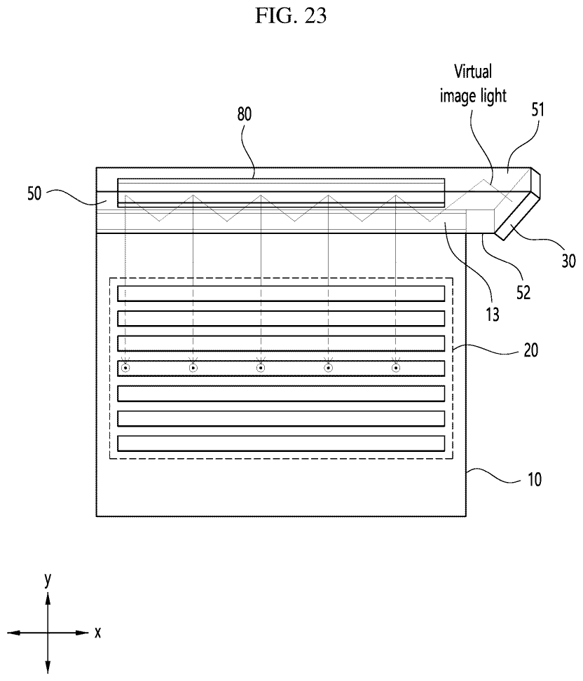

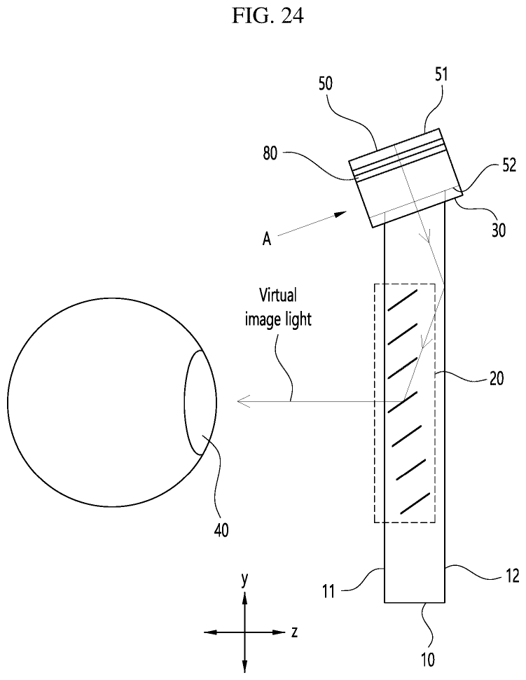

FIGS. 22 to 24 are diagrams illustrating an optical device 700 according to a modification of the second embodiment of the present invention, wherein FIG. 22 is a perspective view, FIG. 23 is a front view, and FIG. 24 is a side view.

The optical device 700 of FIGS. 22 to 24 has the same basic principle as the optical device 600 of FIGS. 18 to 20, except that a first optical element 80 is embedded and disposed inside a first optical means 50.

Except for this, all the components of the optical device 700 are the same as those of the optical device 600 described above, so that detailed descriptions thereof will be omitted.

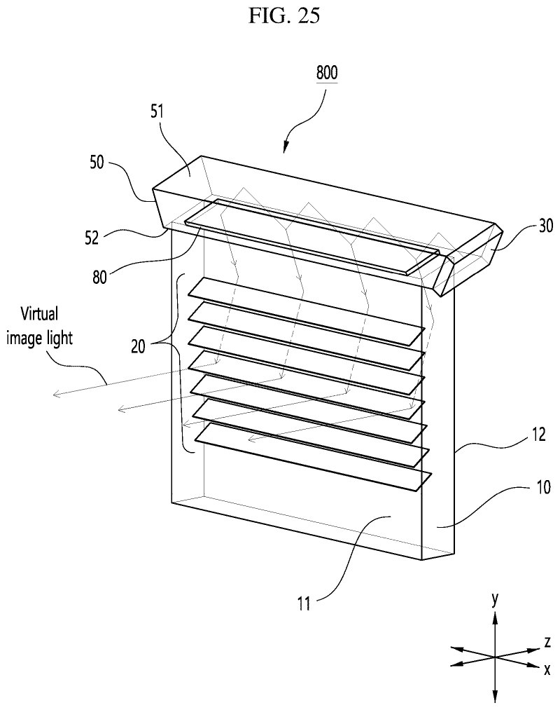

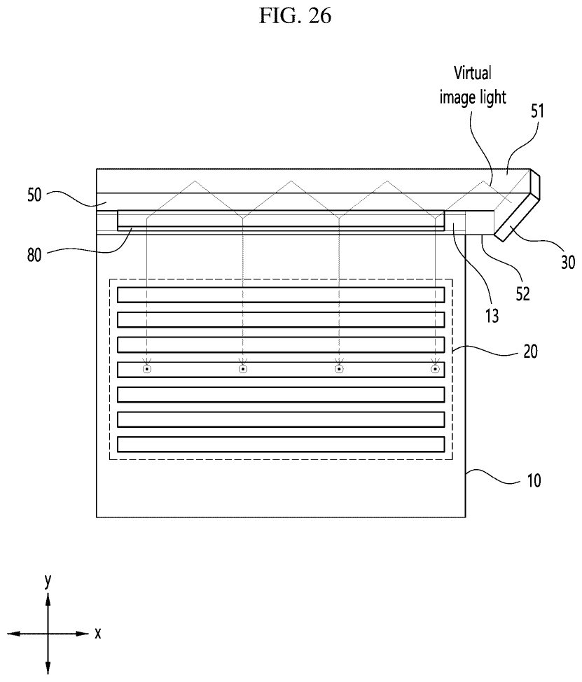

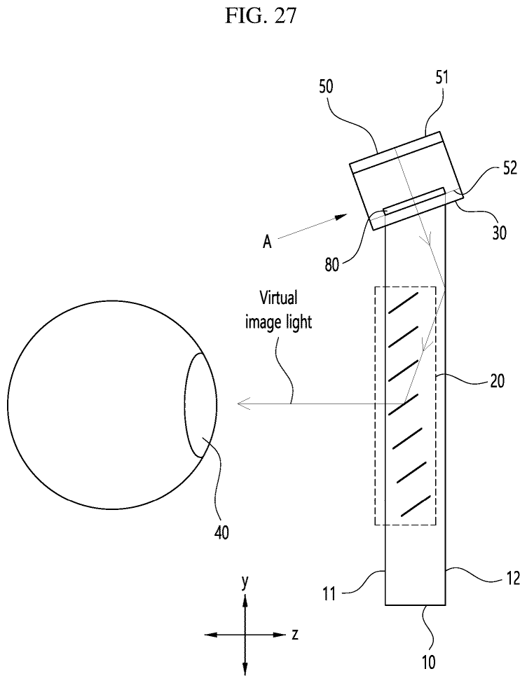

FIGS. 25 to 27 are diagrams illustrating an optical device 800 according to another modification of the second embodiment of the present invention, wherein FIG. 25 is a perspective view, FIG. 26 is a front view, and FIG. 27 is a side view.

The optical device 800 of FIGS. 25 to 27 is the same as the optical device 600 of FIGS. 18 to 20, except that a first optical element 80 is disposed inside the bottom surface 52 of a first optical means 50. In this case, it is obvious that the first optical element 80 may be disposed on an outer surface beneath the bottom surface 52 of the first optical means 50.

Except for this, all the components of the optical device 800 are the same as those of the optical device 600 described above, so that detailed descriptions thereof will be omitted.

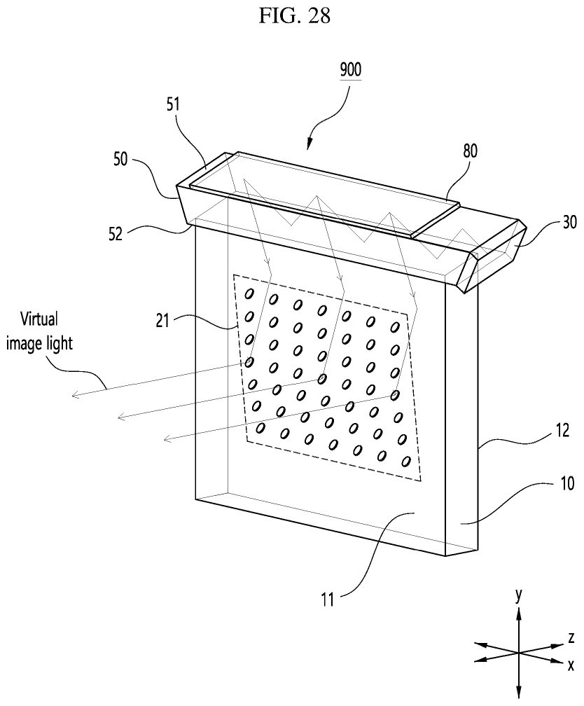

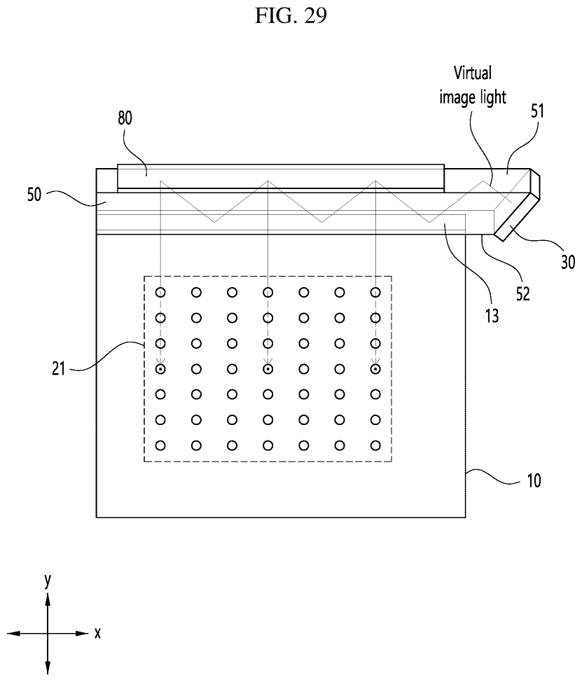

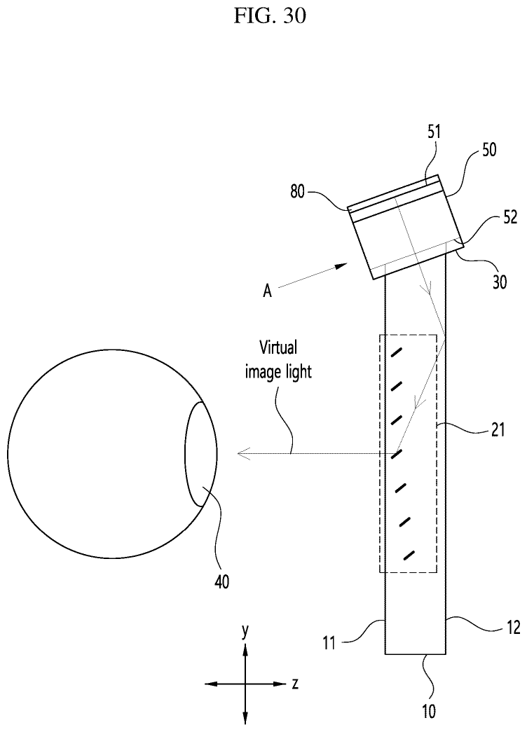

FIGS. 28 to 30 are diagrams illustrating an optical device 900 according to still another modification of the second embodiment of the present invention, wherein FIG. 28 is a perspective view, FIG. 29 is a front view, and FIG. 30 is a side view.

The optical device 900 of FIGS. 28 to 30 is the same as the optical device 600 of FIGS. 18 to 20, except that each of a plurality of second optical elements 20 is formed of a plurality of optical modules 21 in the shape of pinpoints.

That is, in the optical device 900, each of the plurality of second optical elements 20 is formed of the plurality of optical modules 21 that are arranged to be spaced apart from each other and appear in an array form when the optical device 900 is placed in front of the pupil 40 and viewed, as shown in the drawings.

Each of the plurality of optical modules 21 may be formed in a size smaller than the size of a human pupil, i.e., 8 mm or less, preferably 4 mm or less, in order to obtain the pinhole effect by increasing the depth of field.

The size of the plurality of optical modules 21 is defined to mean the maximum length between any two points on the edge boundary of each of the optical modules 21.

Furthermore, the size of each of the optical modules 21 may be the maximum length between any two points on the edge boundary line of the projection of each of the optical modules 21 onto a plane that includes the center of the pupil 40 while being perpendicular to the straight line between the pupil 40 and the optical module 21.

However, the diffraction phenomenon increases when the size is excessively small, so that it is preferable to make it larger than, for example, 0.3 mm.

Furthermore, the shape of each of the plurality of optical modules 21 may be circular.

Furthermore, the optical modules 21 may each be formed in an oval shape to appear circular when viewed from the pupil 40.

Except for this, all the components of the optical device 900 are the same as those of the optical device 600 described above, so that detailed descriptions thereof will be omitted.

Meanwhile, although not shown in the drawings, it is obvious that the plurality of second optical elements 20 are also formed of a plurality of pinpoint-shaped optical modules 21 in the optical devices 700 and 800 of FIGS. 22 to 27.

Although the present invention has been described with reference to the preferred embodiments according to the present invention, it should be noted that these are illustrative and all changes within the equivalent range understood by the attached claims and the accompanying drawings are included in the scope of the present invention.

For example, in the above-described embodiments, the first optical means 50 and the second optical means 10 may be integrated with each other.

Moreover, although in the above-described embodiments, the virtual image light is described as being transferred to the second optical elements 20 through total internal reflection inside the second optical means 10, it is obvious that the virtual image light may be transferred to the second optical elements 20 without total internal reflection or through two or more total internal reflections.

1. An optical device for augmented reality providing an expanded eye box, the optical device comprising:
a first optical means configured such that virtual image light output from an image output unit propagates through an inside thereof;
an optical conversion means embedded and disposed inside the first optical means, and configured to transfer the virtual image light, propagating through the inside of the first optical means, to first optical elements;
the plurality of first optical elements embedded and disposed inside the first optical means, and configured to output the virtual image light, transferred from the optical conversion unit, to a second optical means;
the second optical means configured to transfer real object image light, output from a real object, to a pupil of a user's eye by transmitting the real object image light therethrough, and also configured to allow the virtual image light, output from the first optical elements, to propagate through an inside thereof; and
a plurality of second optical elements embedded and disposed inside the second optical means, and configured to provide a virtual image to the user by transferring the virtual image light, propagating through the inside of the second optical means, to the pupil of the user's eye;
wherein the plurality of first optical elements are arranged at intervals in a first direction inside the first optical means; and
wherein the plurality of second optical elements are arranged at intervals in a second direction inside the second optical means.

2. (canceled)

3. (canceled)

4. (canceled)

5. (canceled)

6. (canceled)

7. The optical device of claim 1, wherein the image output unit is disposed at one end of the first optical means in the first direction.

8. The optical device of claim 1, wherein the optical conversion unit is embedded and disposed inside the first optical means to face the image output unit.

9. The optical device of claim 1, wherein the virtual image light output from the image output unit is reflected by total internal reflection inside the first optical means and transferred to the optical conversion unit, and the virtual image light output from the optical conversion unit is reflected by total internal reflection inside the first optical means and transferred to the first optical elements.

10. The optical device of claim 1, wherein the optical conversion unit is a reflective means that reflects incident light.

11. (canceled)

12. (canceled)

13. (canceled)

14. (canceled)

15. (canceled)

16. The optical device of claim 1, wherein the plurality of first optical elements are reflective means that reflect incident light.

17. (canceled)

18. (canceled)

19. The optical device of claim 1, wherein each of the plurality of first optical elements is formed of a plurality of optical modules.

20. The optical device of claim 19, wherein each of the plurality of first optical elements is formed of a plurality of optical modules that are arranged to be spaced apart from each other and appear in an array form when the optical device for augmented reality is viewed from a side.

21. (canceled)

22. The optical device of claim 1, wherein each of the plurality of second optical elements is arranged to be inclined inside the second optical means so that it can transfer the virtual image light, propagating through the inside of the second optical means, to the pupil.

23. The optical device of claim 22, wherein:
the second optical means has a first surface through which the virtual image light and the real object image light are output toward the user's pupil, and a second surface which faces the first surface and on which the real object image light is incident;
the virtual image light output from the first optical elements is reflected by total internal reflection on the second surface of the second optical means and transferred to the plurality of second optical elements; and
the plurality of second optical elements each are arranged at an inclination angle inside the second optical means so that the virtual image light reflected by total internal reflection on the second surface of the second optical means can be transferred to the pupil.

24. The optical device of claim 1, wherein the plurality of second optical elements each are formed in a bar shape extending in the first direction.

25. (canceled)

26. The optical device of claim 1, wherein each of the plurality of second optical elements is formed of a plurality of optical modules.

27. The optical device of claim 26, wherein each of the plurality of second optical elements is formed of a plurality of optical modules that are arranged to be spaced apart from each other and appear in an array form when the optical device for augmented reality is viewed from a front thereof.

28. (canceled)

29. The optical device of claim 1, wherein the plurality of second optical elements are reflective means that reflect incident light.

30. (canceled)

31. (canceled)

32. (canceled)

33. An optical device for augmented reality providing an expanded eye box, the optical device comprising:
a first optical means configured such that virtual image light output from an image output unit propagates through an inside thereof;
a first optical element disposed in the first optical means, and configured to output the virtual image light, propagating through the inside of the first optical means, to a second optical means;
the second optical means configured to transfer real object image light, output from a real object, to a pupil of a user's eye by transmitting the real object image light therethrough, and also configured to allow the virtual image light, output from the first optical element, to propagate through an inside thereof; and
a plurality of second optical elements embedded and disposed inside the second optical means, and configured to provide a virtual image to the user by transferring the virtual image light, propagating through the inside of the second optical means, to the pupil of the user's eye;
wherein the first optical element is a diffractive optical element or a holographic optical element;
wherein the first optical element is extended in a first direction and arranged in the first optical means; and
wherein the plurality of second optical elements are arranged at intervals in a second direction inside the second optical means.

34. (canceled)

35. (canceled)

36. (canceled)

37. (canceled)

38. (canceled)

39. (canceled)

40. (canceled)

41. (canceled)

42. (canceled)

43. (canceled)

44. The optical device of claim 33, wherein the plurality of second optical elements each are formed in a plate shape extending in the first direction.

45. (canceled)

46. The optical device of claim 33, wherein each of the plurality of second optical elements is formed of a plurality of optical modules.

47. (canceled)

48. (canceled)

49. (canceled)

50. (canceled)

51. (canceled)

52. (canceled)
